(19) United States
(12) Patent Application Publication
(10) Pub. No.: US 2024/0037891 A1
(43) Pub. Date: Feb. 1, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: RYO KAZUMI, Kanagawa (JP)

(21) Appl. No.: 18/351,758

(22) Filed: Jul. 13, 2023

(30) Foreign Application Priority Data
Jul. 27, 2022 (JP) 2022-119235

(51) Int. Cl. G06V 10/24; G06T 7/00; G06T 3/00; G06V 10/44

(52) U.S. Cl. CPC G06V 10/245; G06T 7/001; G06T 3/0006; G06V 10/44; G06T 2207/30144

(57) ABSTRACT

The image processing apparatus derives first alignment information for performing alignment of an inspection image and a reference image by using feature points extracted from the inspection image and the reference image, respectively, and performs alignment of the inspection image and the reference image by using the first alignment information. In a case where feature points more than or equal to a certain number are not extracted from the inspection image and the reference image, alignment is performed by using alternative alignment information by estimating the alternative alignment information from the first alignment information used in past alignment or the first alignment information derived by parameter adjustment for the alignment.

### BACKGROUND

### Field

The present disclosure relates to an image processing apparatus, an image processing method, and a storage medium

### Description of the Related Art

There is a printing system that inspects a sheet printed by a printing apparatus during conveyance by an inspection apparatus. The inspection apparatus determines whether or not a printed sheet is normal by reading the image of the conveyed printed sheet, analyzing the image, and based on the analysis results. In a case where, for example, a missing barcode or ruled line, a printing failure or the like is detected by the image analysis, the inspection apparatus determines that the printed sheet in which a printing failure or the like is detected to be not normal. The printed sheet determined to be not normal (defective sheet) is discharged to a discharge destination different from that for a printed sheet determined to be normal (normal sheet). Due to this, the defective sheet is prevented from being mixed with the normal sheet, and therefore, it is made possible for an operator to discard the defective sheet.

In the above-described image analysis, a reference image that is taken to be a reference for inspection is used and for example, alignment by feature points extracted from the reference image and an inspection image, respectively, and alignment by sheet four corners detected from the reference image and the inspection image, respectively, are performed. By performing alignment by feature points, scan misalignment resulting from a scan and print misalignment resulting from printing are corrected. By performing alignment by sheet four corners, scan misalignment resulting from a scan is corrected. As regards the extraction of feature points for alignment, Japanese Patent Laid-Open No. 2019-149078 has disclosed a technique to switch feature point extraction methods in accordance with whether or not it is possible to detect an edge in a reference image. In a case of a reference image in which it is possible to detect an edge, the method is switched to a feature point extraction method using a feature point detection algorithm with reference to edge and in a case of a reference image in which it is not possible to detect an edge, the method is switched to a feature point extraction method using a reference feature point detection algorithm with reference to gradation.

In a case where it is not possible to extract a sufficient number of feature points, alignment is switched to alignment by sheet four corners. Due to this, both the inspection in a case where alignment by feature points is performed and the inspection in a case where alignment by sheet four corners is performed are made to coexist.

### SUMMARY

In a case where the number of feature points that can be extracted from the inspection image and the reference image is small, it is not possible to correct print misalignment resulting from printing, and therefore, there is a possibility that the accuracy of alignment of the inspection image and the reference image is reduced.

The image processing apparatus according to one aspect of the present disclosure is an image processing apparatus that performs image processing for performing alignment of an inspection image obtained by reading a printed material and a reference image of the inspection image and comprises: an extraction unit configured to extract feature points from the inspection image and the reference image, respectively; a first derivation unit configured to derive first alignment information for performing alignment of the inspection image and the reference image by using feature points extracted from the inspection image and the reference image, respectively; and an alignment unit configured to perform alignment of the inspection image and the reference image by using the first alignment information, wherein the alignment unit performs, in a case where feature points more than or equal to a certain number are not extracted from the inspection image and the reference image, alignment by using alternative alignment information by estimating the alternative alignment information from the first alignment information used in past alignment or the first alignment information derived by parameter adjustment for the alignment.

Further features of the present disclosure will become apparent from the following description of exemplary embodiments with reference to the attached drawings.

### BRIEF DESCRIPTION OF THE DRAWINGS

FIG. 1 is a diagram showing a configuration example of a printing system;

FIG. 2 is a diagram showing the relationship of FIG. 2A and FIG. 2B;

FIG. 2A is a block diagram showing an internal configuration of an image forming apparatus, an external controller, and a client PC of the printing system;

FIG. 2B is a block diagram showing an internal configuration of an image forming apparatus, an external controller, and a client PC of the printing system;

FIG. 3 is a mechanical cross-sectional diagram of the image forming apparatus;

FIG. 4 is a diagram showing the relationship of FIG. 4A and FIG. 4B;

FIG. 4A is a flowchart showing a flow of inspection processing;

FIG. 4B is a flowchart showing a flow of inspection processing;

FIG. 5 is a flowchart showing a flow of processing of inspection method detailed setting;

FIG. 6 is a diagram showing a UI screen example for setting an inspection method;

FIG. 7A to FIG. 7D are diagrams explaining feature point extraction;

FIG. 8A to FIG. 8C are diagrams explaining the Harris corner detection method;

FIG. 9A and FIG. 9B are each a diagram showing an image example in which the number of feature points is small;

FIG. 10 is a diagram showing processing to estimate alignment information;

FIG. 11 is a flowchart showing a detailed flow of inspection processing;

FIG. 12 is a flowchart showing a detailed flow of comparison processing with a reference image;

FIG. 13 is a diagram showing the relationship of FIG. 13A and FIG. 13B;

FIG. 13A is a flowchart showing a flow of inspection processing;

FIG. 13B is a flowchart showing a flow of inspection processing;

FIG. 14 is a flowchart showing a detailed flow of inspection parameter adjustment processing;

FIG. 15 is a diagram showing the relationship of FIG. 15A and FIG. 15B;

FIG. 15A is a flowchart showing a flow of inspection processing; and

FIG. 15B is a flowchart showing a flow of inspection processing.

### DESCRIPTION OF THE EMBODIMENTS

In the following, with reference to the attached drawings, embodiments of the technique of the present disclosure are explained in detail. The following embodiments are not intended to limit the technique of the present disclosure according to the claims and all combinations of features explained in the present embodiments are not necessarily indispensable to the solution of the technique of the present disclosure. To the same components, the same reference numbers are attached and explanation thereof is omitted.

In the following explanation, the external controller is sometimes called an image processing controller, a digital front end, a printer server, a DFE and the like. The image forming apparatus is sometimes called a multi function peripheral, an MFP and the like.

### First Embodiment

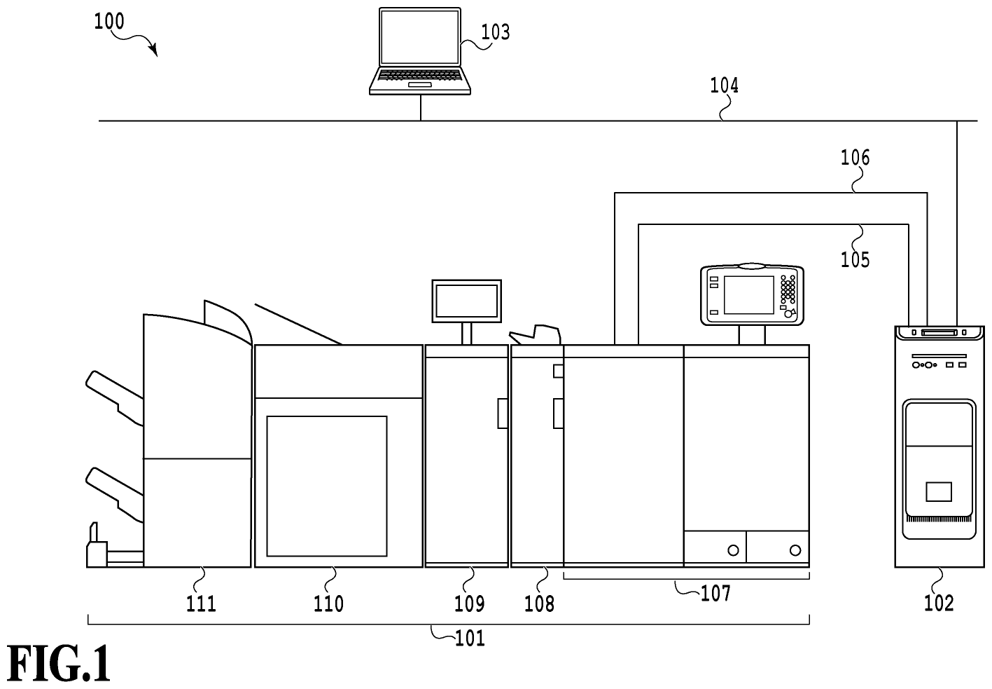

FIG. 1 is a diagram showing a configuration example of a printing system according to the present embodiment. A printing system 100 includes an image forming apparatus 101 and an external controller 102. The image forming apparatus 101 and the external controller 102 are connected so as to be capable of communication via an internal LAN 105 and a video cable 106. Further, the external controller 102 is connected with a client PC 103 so as to be capable of communication via an external LAN 104. Printing instructions are given to the external controller 102 by the client PC 103.

In the client PC103, a printer driver is installed, which has a function to convert print processing target-image data into page description language (PDL) that the external controller 102 can process. It is possible for a user who desires to perform printing to give printing instructions via the printer driver from various applications. The printer driver transmits PDL data to the external controller 102 based on printing instructions from a user. Upon receipt of PDL data from the client PC 103, the external controller 102 generates print data (in the following, called “print job”) that the image forming apparatus 101 can process by performing PDL analysis and rasterizing processing and inputs the print job to the image forming apparatus 101.

Next, the image forming apparatus 101 is explained. In the image forming apparatus 101, devices having a plurality of different functions is connected and configured so that complicated print processing, such as bookbinding, can be performed. The image forming apparatus 101 has a printing module 107, an inserter 108, an inspection module 109, a stacker 110, and a finisher 111. In the following, each module is explained.

The printing module 107 forms an image using toner as a printing material on a sheet as a printing medium, which is conveyed from a sheet feed unit 230, in accordance with a print job. The configuration and the operation principle of the printing module 107 are as follows. A laser beam modulated in accordance with an image designated in a print job is reflected from a rotating polygon mirror, such as a polygon mirror, and a photoconductor drum is irradiated with the laser beam as a scanning beam. An electrostatic latent image formed on the photoconductor drum by the laser beam is developed by toner and a toner image is transferred to a sheet pasted onto a transfer drum. By sequentially performing the series of image formation processes for the toner of each of yellow (Y), magenta (M), cyan (C), and black (K), a full-color image is formed on the sheet. The sheet on the transfer drum, on which the full-color image is formed, is conveyed to a fixing unit. The fixing unit includes a roller, a belt and the like and incorporates a heat source, such as a halogen heater, within the roller and dissolves the toner on the sheet on which the full-color image is formed by applying heat and pressure and fixes the toner onto the sheet.

The inserter 108 is a device that inserts a partitioning sheet or the like for separating a sheet group for which the print processing has been performed in the printing module 107 and which is conveyed, for example, at an arbitrary position.

The inspection module 109 determines whether the image formed on the sheet is normal, that is, determines the presence/absence of a print defect by reading the image on a print-processed sheet that is conveyed and comparing it with a reference image registered in advance.

The stacker 110 is a large-capacity stacking device capable of stacking print-processed sheets. The finisher 111 is a postprocessing device having various finishing processing functions, such as stapling, punching, and saddle stitching bookbinding. The finisher 111 performs finishing processing that is selected and set in advance for the conveyed print-processed sheet. The sheet for which the finishing processing has been performed is discharged onto a sheet discharge tray.

Though the printing system explained in FIG. 1 has the configuration in which a print job is input via the external controller 102, a configuration in which, for example, the external controller 102 is omitted may also be accepted. That is, the configuration may also be one in which the image forming apparatus 101 is connected to the external LAN 104 and from the client PC 103, PDL data is transmitted to the image forming apparatus 101. In this case, the print processing is performed after generating a print job by performing PDL analysis and rasterizing processing in the image forming apparatus 101. Further, in the example in FIG. 1, though the external controller 102 and the image forming apparatus 101 are connected by the internal LAN 105 and the video cable 106, the configuration is only required to be capable of performing transmission and reception of data necessary for printing. For example, the configuration may be one having only one of the internal LAN 105 and the video cable 106.

### <Internal Configuration of Printing System>

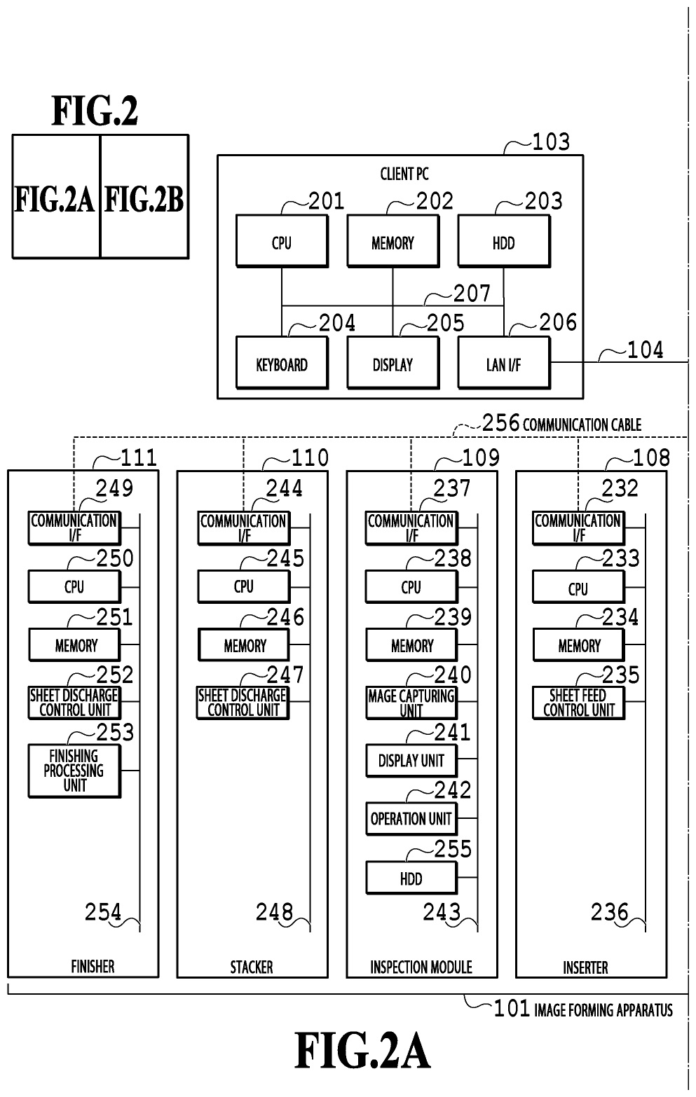

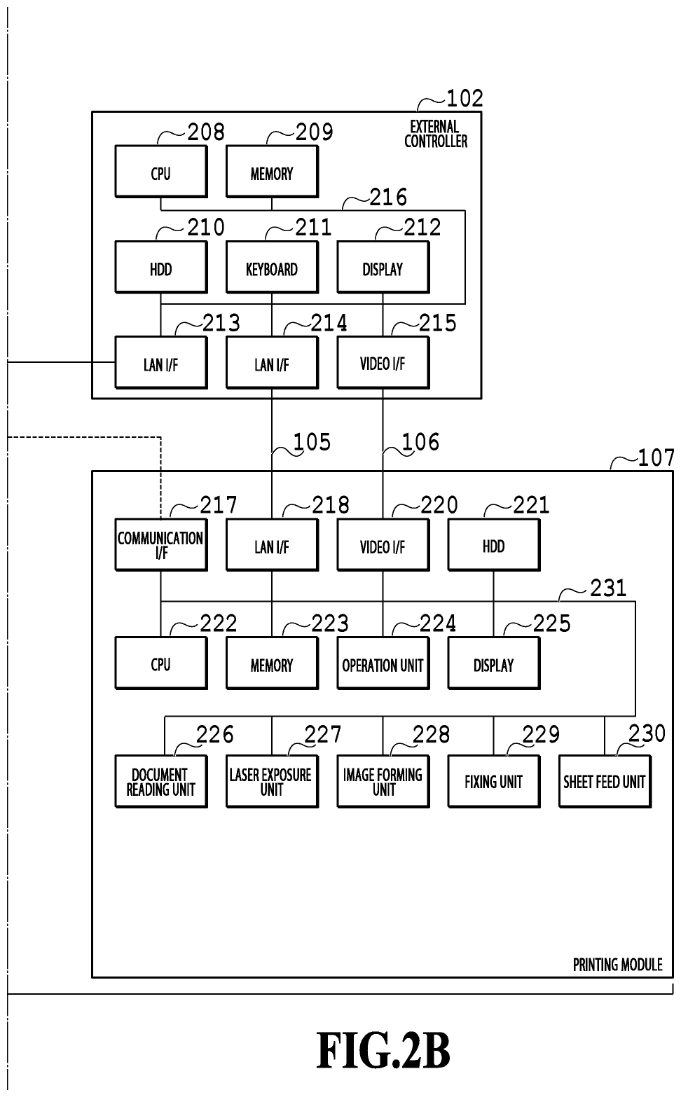

FIGS. 2A and 2B are block diagrams showing the internal configuration of the image forming apparatus 101, the external controller 102, and the client PC 103 configuring the printing system 100. In the following, explanation is given in order.

### <<Internal Configuration of Image Forming Apparatus>>

First, the internal configuration of the printing module 107 of the image forming apparatus 101 is explained. The printing module 107 has, as components relating mainly to control, a communication I/F 217, a LAN I/F 218, a video I/F 220, an HDD 221, a CPU 222, a memory 223, an operation unit 224, and a display 225. Further, the printing module 107 has, as components relating mainly to image formation, a document reading unit 226, a laser exposure unit 227, an image forming unit 228, a fixing unit 229, and the sheet feed unit 230. Each component is connected via a system bus 231.

The communication I/F 217 is connected with the inserter 108, the inspection module 109, the stacker 110, and the finisher 111 via a communication cable 256 and communication for controlling each device is performed. The LAN I/F 218 is connected with the external controller 102 via the internal LAN 105 and communication of print data and the like is performed. The video I/F 220 is connected with the external controller 102 via the video cable 106 and communication of image data and the like is performed. The HDD 221 is a storage device in which programs and data are stored. The CPU 222 controls the printing module 107 comprehensively based on programs and the like stored in the HDD 221. In the memory 223, programs and image data necessary at the time of the CPU 222 performing various kinds of processing are stored and the memory 223 operates as a work area. The operation unit 224 receives inputs of various settings and operation instructions from a user. The display 225 displays information on various settings relating to print processing, the processing situation of a print job, and the like.

The document reading unit 226 is a scanner device that optically reads a document at the time of using the copy function and the scan function. The document reading unit 226 optically reads the image on a document by capturing the image with a CMOS image sensor while illuminating the sheet disposed by a user with an exposure lamp and generates image data. The laser exposure unit 227 is a device that performs primary charging and laser exposure for irradiation with a laser beam. The laser exposure unit 227 first performs primary charging that charges the photoconductor drum surface to a uniform negative potential. Next, the laser exposure unit 227 irradiates the photoconductor drum with the laser beam by a laser driver while adjusting the reflection angle with a polygon mirror. Due to this, the negative charges at the irradiated portion are neutralized and an electrostatic latent image is formed. The image forming unit 228 is a device for transferring toner onto the sheet. The image forming unit 228 includes a developing unit, a transfer unit, a toner replenishment unit and the like, which are not shown schematically, and transfers the toner on the photoconductor drum onto the sheet. The developing unit attaches the negatively charged toner from a developing cylinder to the electrostatic latent image on the photoconductor drum surface and visualizes the electrostatic latent image. The transfer unit performs primary transfer that transfers the toner on the photoconductor drum surface onto a transfer belt by applying a positive potential to a primary transfer roller and secondary transfer that transfers the toner on the transfer belt onto the sheet by applying a positive potential to a secondary transfer outer roller. The fixing unit 229 is a device that dissolves and fixes the toner on the sheet onto the sheet by applying heat and pressure and includes a heating heater, a fixing belt, a pressure belt and the like, which are not shown schematically. The sheet feed unit 230 is a device for feeding a sheet that is subjected to print processing. The sheet feed unit 230 performs the sheet feed operation and the conveyance operation of a sheet by a roller and various sensors, which are not shown schematically.

Next, the internal configuration of the inserter 108 of the image forming apparatus 101 is explained. The inserter 108 includes a communication I/F 232, a CPU 233, a memory 234, and a sheet feed control unit 235 and each component is connected via a system bus 236. The communication I/F 232 is connected with the printing module 107 via the communication cable 256 and performs communication necessary for sheet insertion control. The CPU 233 controls the entire inserter 108 in accordance with control programs stored in the memory 234. The memory 234 is a storage device in which control programs are stored. The sheet feed control unit 235 controls the intake of a sheet disposed on a tray 321, sheet feed from a sheet feed unit, not shown schematically, and conveyance of a sheet that is conveyed from the printing module 107 while controlling a roller and a sensor, which are not shown schematically, based on instructions from the CPU 233.

Next, the internal configuration of the inspection module 109 of the image forming apparatus 101 is explained. The inspection module 109 includes a communication I/F 237, a CPU 238, a memory 239, an image capturing unit 240, a display unit 241, an operation unit 242, and an HDD 255 and each component is connected via a system bus 243. The communication I/F 237 is connected with the printing module 107 via the communication cable 256 and performs communication necessary for control, such as inspection of print-processed sheets. The CPU 238 controls the entire inspection module 109 in accordance with control programs stored in the memory 239. The memory 239 is a storage device that stores control programs. The image capturing unit 240 reads the image on a print-processed sheet that is conveyed by image capturing based on instructions of the CPU 238. The CPU 238 stores the image captured by the image capturing unit 240 in the memory 239 as a reference image. Further, the CPU 238 compares the inspection-target captured image (inspection image) obtained by the image capturing unit 240 and the reference image stored in advance in the memory 239 and determines whether there is a defect in the print results. That is, it can be said that the CPU 238 determines whether the image on the print-processed sheet is normal. On the display unit (display device) 241, the inspection results, the setting screens and the like are displayed. The operation unit 242 is operated by a user and receives instructions to change the setting of the inspection module 109, to register a reference image, and so on. The HDD 255 stores various kinds of setting information and image data necessary for inspection. It is possible to reuse various kinds of setting information and image data stored in the HDD 255.

Next, the internal configuration of the stacker 110 of the image forming apparatus 101 is explained. The stacker 110 includes a communication I/F 244, a CPU 245, a memory 246, and a sheet discharge control unit 247 and each component is connected via a system bus 248. The communication I/F 244 is connected with the printing module 107 via the communication cable 256 and performs communication necessary for sheet stacking and sheet discharge control. The CPU 245 controls the entire stacker 110 in accordance with control programs stored in the memory 246. The memory 246 is a storage device in which control programs are stored. The sheet discharge control unit 247 performs control for conveying a conveyed sheet to a stack tray, an escape tray, or the subsequent finisher 111 based on instructions from the CPU 245.

Next, the internal configuration of the finisher 111 of the image forming apparatus 101 is explained. The finisher 111 includes a communication I/F 249, a CPU 250, a memory, 251, a sheet discharge control unit 252, and a finishing processing unit 253 and each component is connected via a system bus 254. The communication I/F 249 is connected with the printing module 107 via the communication cable 256 and performs communication necessary for control of finishing processing. The CPU 250 controls the entire finisher 111 in accordance with control programs stored in the memory 251. The memory 251 is a storage device in which control programs are stored. The sheet discharge control unit 252 controls sheet conveyance and sheet discharge based on instructions from the CPU 250. The finishing processing unit 253 performs processing, such as stapling, punching, and saddle stitching bookbinding, based on instructions from the CPU 250.

### <<Internal Configuration of External Controller>>

Next, the internal configuration of the external controller 102 is explained, which is an information processing apparatus. The external controller 102 includes a CPU 208, a memory 209, an HDD 210, a keyboard 211, a display 212, a LAN I/F 213, a LAN I/F 214, and a video I/F 215 and each component is connected via a system bus 216.

The CPU 208 performs reception of PDL data from the client PC 103 based on programs and data stored in the HDD 210. Further the CPU 208 performs processing, such as RIP (Raster Image Processer) processing and transmission of a print job to the image forming apparatus 101. Furthermore, the CPU 208 is also capable of performing RIP processing for reference image data. Specifically, in the RIP processing for reference image data, the CPU 208 generates image data by converting, for example, a resolution of 600 dpi to 300 dpi. In the RIP processing for print data, the CPU 208 generates image data without reducing the resolution.

The memory 209 stores programs and data necessary at the time of the CPU 208 performing various kinds of processing and operates as a work area. The HDD 210 stores programs and data necessary for operations, such as PDL analysis and RIP processing. The keyboard 211 is an input device for a user to input various operations and instructions to the external controller 102. On the display 212, information on the processing situation and the like of an application being executed by the external controller 102 and the input print job is displayed in a still image or in a moving image. The LAN I/F 213 is connected with the client PC 103 via the external LAN 104 and reception of PDL data and the like are performed. The LAN I/F 214 is connected with the image forming apparatus 101 via the internal LAN 105 and transmission of a print job and the like are performed. It is possible for the external controller 102 to perform transmission and reception of various kinds of data with the printing module 107, the inserter 108, the inspection module 109, the stacker 110, and the finisher 111 via the internal LAN 105 and the communication cable 256.

The video I/F 215 is connected with the image forming apparatus 101 via the video cable 106 and transmission, reception and the like of image data are performed.

### <<Internal Configuration of Client PC>>

Next, the internal configuration of the client PC 103 is explained, which is an information processing apparatus. The client PC 103 includes a CPU 201, a memory 202, an HDD 203, a keyboard 204, a display 205, and a LAN I/F 206 and each is connected via a system bus 207. The CPU 201 creates print processing target-image data and gives printing instructions based on a document creation program or the like stored in the HDD 203. Further, the CPU 201 comprehensively controls each device connected to the system bus 207. The memory 202 stores programs and data necessary at the time of the CPU 201 performing various kinds of processing and operates as a work area. The HDD 203 stores programs and data necessary for operations, such as print processing. The keyboard 204 is an input device for a user to input various operations and instructions to the client PC 103. On the display 205, information on an application or the like being executed by the client PC 103 is displayed in a still image or in a moving image. The LAN I/F 206 is connected with the external LAN 104 and transmission and the like of PDL data are performed.

Thought the external controller 102 and the image forming apparatus 101 are connected by the internal LAN 105 and the video cable 106, the configuration is required only to be capable of performing transmission and reception of data necessary for printing. For example, the configuration may be one in which they are connected only by the video cable. Further, each of the memory 202, the memory 209, the memory 223, the memory 234, the memory 239, the memory 246, and the memory 251 shown in FIGS. 2A and 2B is required only to be a storage device for storing data and programs. For example, the configuration may be one in which those memories are replaced with a volatile RAM, a nonvolatile ROM, a built-in HDD, an external HDD, a USB memory and the like.

### <Conveyance System of Image Forming Apparatus>

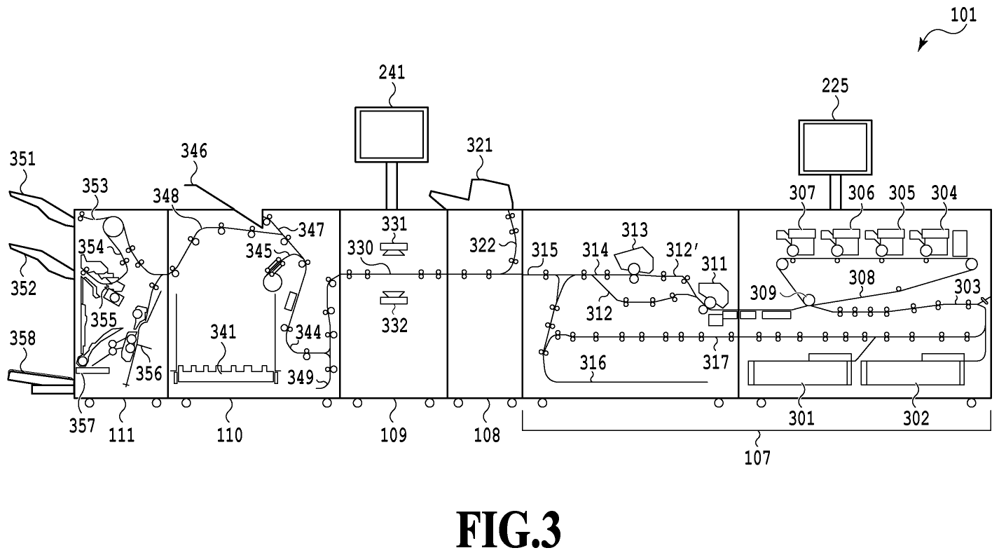

Following the above, the conveyance system of the image forming apparatus 101 is explained. FIG. 3 is a mechanical cross-sectional diagram of the image forming apparatus 101. In the following, explanation is given along FIG. 3.

The printing module 107 is a module that forms an image to be printed on a sheet. The printing module 107 comprises sheet feed decks 301 and 302. It is possible to store various sheets in each of the sheet feed decks 301 and 302. Each of the sheet feed decks 301 and 302 separates only one sheet located at the uppermost position of the stored sheets and conveys the sheet to a sheet conveyance path 303. Each of developing stations 304 to 307 forms a toner image by using colored toner of Y, M, C, or K for forming a color image. The formed toner image is first transferred primarily onto an intermediate transfer belt 308. Then, the intermediate transfer belt 308 rotates clockwise in FIG. 3 and at a secondary transfer position 309, the toner image is transferred onto the sheet conveyed from the sheet conveyance path 303. On the display (display device) 225, the processing situation of a print job and information for various settings are displayed. A fixing unit 311 comprises a pressure roller and a heating roller and fixes the toner image onto the sheet by the sheet passing between each roller and the toner being fused and crimped. The sheet having exited the fixing unit 311 is conveyed to a sheet conveyance path 315 through a sheet conveyance path 312. In a case where the sheet is a sheet type that further requires fusion and crimp to fix the toner image, after passing through the fixing unit 311, the sheet is conveyed to a second fixing unit 313 through a sheet conveyance path 312′ located above the sheet conveyance path 312. The sheet for which additional fusion and crimp have been performed in the second fixing unit 313 is conveyed to the sheet conveyance path 315 through a sheet conveyance path 314. Here, in a case where the setting of the print mode is set to double-sided printing, the sheet is conveyed to a sheet reversing path 316 and after being reversed, the sheet is conveyed to a double-sided conveyance path 317. Then, at the secondary transfer position 309, image transfer onto the second side is performed.

In a case where the number of sheets conveyed to the inserter 108 through the sheet conveyance path 315 reaches a predetermined number of sheets, the inserter 108 merges a partition sheet fed through a sheet conveyance path 322 with the conveyance path. Due to this, it is made possible to insert the partition sheet into a series of sheet groups conveyed from the printing module 107 at arbitrary timing and convey them to the subsequent device.

The sheet having passed through the inserter 108 is conveyed to the inspection module 109. Within the inspection module 109, CISs (Contact Image Sensors) 331 and 332 configuring the image capturing unit 240 are arranged so as to face each other. The CIS 331 is a sensor for reading the front side of the sheet and the CIS 332 is a sensor for reading the back side of the sheet. The image capturing unit 240 may be configured by, for example, a line scan camera in place of the CIS. The inspection module 109 reads the images on both sides of the sheet by using the CISs 331 and 332 at the timing at which the sheet conveyed to a sheet conveyance path 333 reaches a predetermined position and inspects whether there is a defect in the read image of the inspection-target side. That is, it is possible to determine (inspect) whether the image is normal. On the display device 241, results of the inspection performed by the inspection module 109, and the like are displayed. The inspected sheet is conveyed to the stacker.

The stacker 110 has a stack tray 341 for stacking sheets. The sheet having passed through the inspection module 109 is conveyed to the stacker 110 through a sheet conveyance path 344. The sheet conveyed from the sheet conveyance path 344 via a sheet conveyance path 345 is stacked on the stack tray 341 while being flipped. Further, the stacker 10 has an escape tray 346 as a sheet discharge tray. The escape tray 346 is a sheet discharge tray for discharging the sheet determined to have a print defect (image defect) by the inspection module 109. In a case where a sheet is discharged onto the escape tray 346, the sheet is conveyed to the escape tray 346 from the sheet conveyance path 344 via a sheet conveyance path 347. In a case where a sheet is conveyed to the finisher 111 in the subsequent stage of the stacker 110, the sheet is conveyed via a sheet conveyance path 348. The stacker further has a reversing unit 349 for reversing the orientation of a sheet that is conveyed. The reversing unit 349 is used in a case where a sheet is stacked on the stack tray 341. In a case where a sheet is stacked on the stack tray 341 so that the orientation of the input sheet and the orientation of the sheet at the point in time of output are the same, the sheet is reversed once in the reversing unit 349. In a case where a sheet is conveyed to the escape tray 346 or the subsequent finisher 111, the sheet is discharge as it is without being flipped at the time of stacking, and therefore, the reversing operation in the reversing unit 349 is not performed.

In the finisher 111, for the conveyed sheet, the finishing function designated by a user is performed. In the present embodiment, the finisher 111 has the finishing function, for example, such as the stapling function (one-portion or two-portion stapling), the punching function (two-hole or three-hole punching), and the saddle stitching bookbinding function. The finisher 111 comprises two sheet discharge trays 351 and 352. In a case where the finishing processing by the finisher 111 is not performed, the sheet conveyed to the finisher 111 is discharged onto the sheet discharge tray 351 via a sheet conveyance path 353. In a case where the finishing processing, such as stapling processing, is performed by the finisher 111, the sheet conveyed to the finisher 111 is guided to a sheet conveyance path 354. The finisher 111 performs the finishing processing designated by a user for the sheet that is conveyed through the sheet conveyance path 354 by using a first processing mechanism 355 and discharges the sheet for which the finishing processing has been performed onto the sheet discharge tray 352. The sheet discharge trays 351 and 352 are each configured so as to be capable of going up and down. It is also possible for the finisher 111 to operate to stack the sheet for which the finishing processing by the first processing mechanism 355 has been performed onto the sheet discharge tray 351 by lowering the sheet discharge tray 351.

In a case where the saddle stitching bookbinding processing is designated by a user, the finisher 111 performs the stapling processing at the center of the sheet by using a second processing mechanism (saddle stitching processing unit) 356 and then generates a bookbinding product by folding the sheet in half. The finisher 111 discharges the generated bookbinding product onto a bookbinding tray 358 via a sheet conveyance path 357. The bookbinding tray 358 has a belt conveyer configuration for conveying the bookbinding product stacked on the bookbinding tray 358 to the outside of the apparatus.

### <Details of Inspection Module>

Following the above, the method of using the inspection module 109 is explained in detail, such as various kinds of setting work that a user should perform for the inspection module 109 before starting inspection processing. The inspection module 109 inspects a conveyed print-processed sheet in accordance with an inspection item set in advance. The inspection is performed by comparing the read image (in the following, called “inspection image”) corresponding to the inspection-target side of the read images on both sides of the sheet obtained by capturing the print-processed sheet and the reference image registered in advance in association with the sheet side indicating one of the obverse side and the reverse side. As the image comparison method, there are a method of comparing the pixel values for each corresponding position in both images and a method of comparing the object positions obtained by edge detection. Further, there is a method by extraction of character data by optical character recognition (OCR) processing. The inspection item includes print misalignment, image hue, image density, streak, fading, missing print dots and the like.

### <Flow of Entire Inspection Processing>

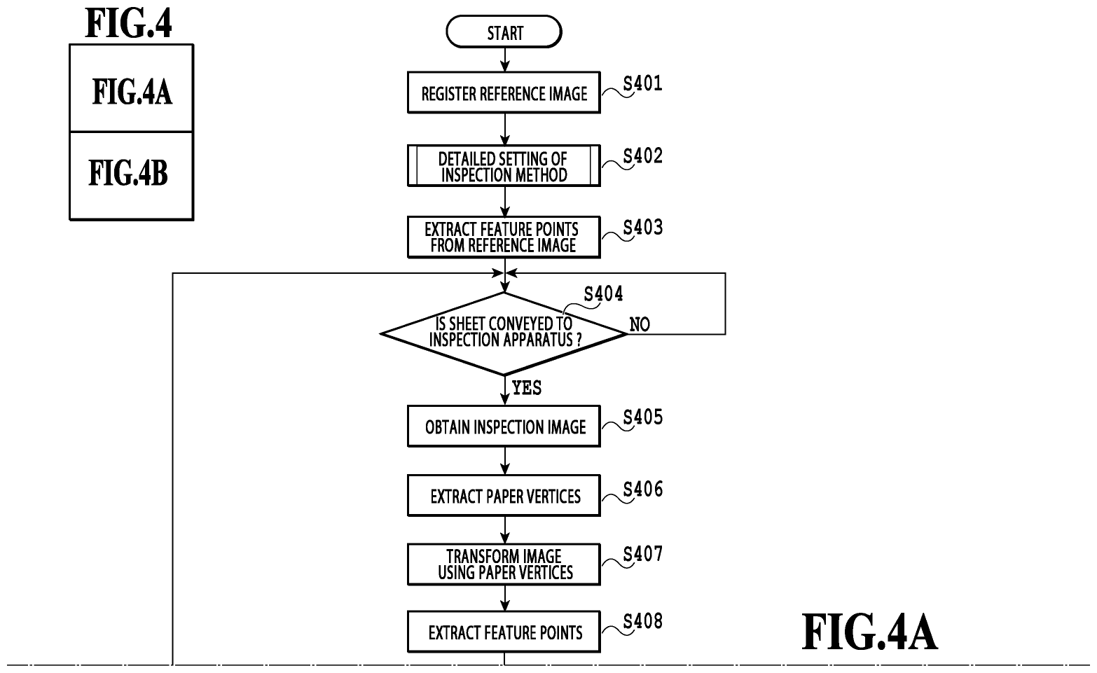

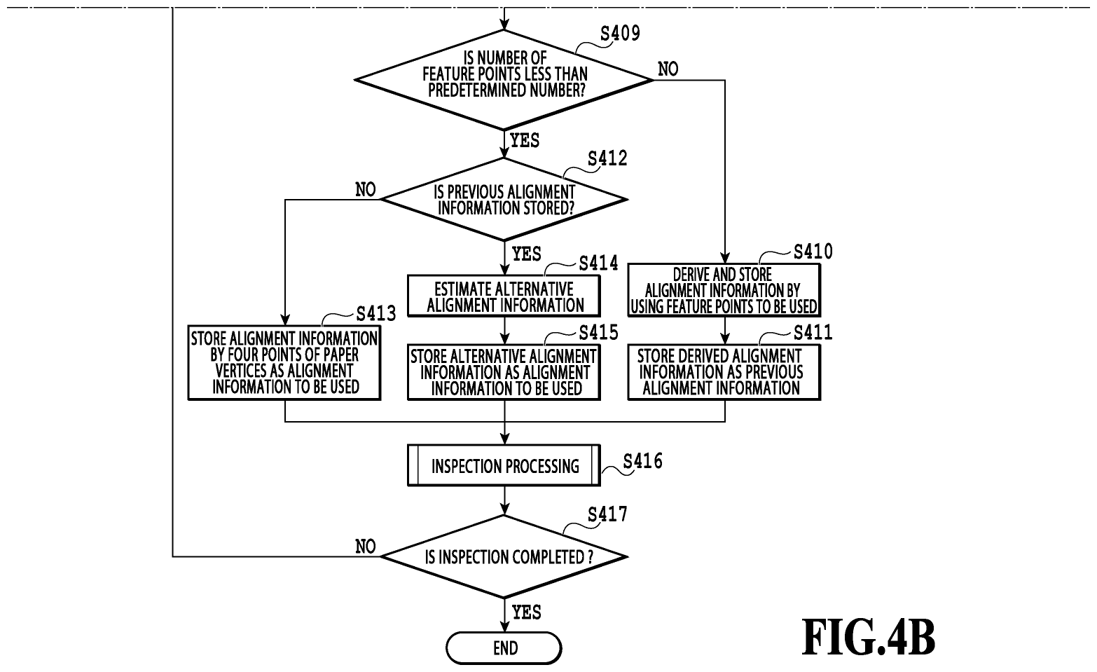

Next, a flow of entire inspection processing by the inspection module 109 of the printing system according to the present embodiment is explained. FIGS. 4A and 4B are flowcharts showing a flow of entire inspection processing. In FIGS. 4A and 4B, the entire flow from the work before starting inspection until the execution of inspection is shown. A symbol “S” in the explanation of the flowchart represents a step. This is the same with the explanation of the following flowcharts. Each piece of processing in FIGS. 4A and 4B is performed by the inspection module 109 in accordance with the operation from the client PC 103 of a user.

First, at S401, the inspection module 109 registers a reference image that is used in inspection of an inspection-target inspection image. As the reference image creation method, there are two methods. The first method is a method of generating a reference image by performing a print job and performing a scan with the image capturing unit 240. Specifically, the inspection module 109 stands by in the reference image reading mode and in a case where a print job for reference image registration is input from the client PC 103, the inspection module 109 performs the input print job and prints an image in accordance with the print job on a sheet and conveys the sheet. Then, the inspection module 109 detects the conveyance and scans the sheet on which the image is printed with the CIS 331 (image capturing unit 240) and stores the scanned image obtained by the scan in the memory 239 as a reference image.

The other method is a method in which the image data after RIP processing to generate image data by analyzing print data is taken to be a reference image in place of using a scanned image. At S402 and subsequent steps, the method of generating a reference image by performing a print job and performing a scan with the CIS 331 (image capturing unit 240) is explained. Sheet vertices (four corners) are detected from the reference image and the detected sheet vertices (four corners) are transformed into the shape of a sheet and registered together with the reference image. In a case where image data after RIP processing is registered as a reference image, the processing in which sheet vertices (four corners) are detected from the reference image is skipped and matching with vertex coordinates determined in advance is performed.

At S402, the inspection module 109 sets detailed information, such as the inspection level, the inspection type, and the inspection area in a case where the image of a print-proceed sheet is inspected, in accordance with the operation of a user. Details will be described later.

At S403, the inspection module 109 extracts feature points from the reference image registered at S401. In this feature point extraction processing, feature points are extracted based on, for example, various kinds of feature amount calculation algorithm (Harris Corner Detection, Fast Corner Detection, AKAZE and the like).

At S404, the inspection module 109 determines whether a print-processed sheet is conveyed to the inspection module 109. In a case where determination results that a print-processed sheet is not conveyed are obtained (NO at S404), the processing is returned to S404. In a case where determination results that a print-processed sheet is conveyed are obtained (YES at S404), the processing is moved to S405.

At S405, the inspection module 109 reads the image of the print-processed sheet by using the CIS 331 and the CIS 332 and stores the image in the memory 239 of the inspection module 109. That is, the inspection module 109 obtains an inspection image and stores the obtained inspection image in the memory 239 of the inspection module 109.

At S406, the inspection module 109 extracts the positions of the sheet vertices (positions of vertices) from the inspection image obtained at S405. In the present embodiment, the sheet vertices refer to the four corners of the print-processed sheet. As the extraction method of sheet vertex positions, a publicly known technique is used. By using the sheet vertices extracted from the inspection image and the sheet vertices of the reference image registered at S401, alignment information (second alignment information) by sheet vertices for performing alignment of the inspection image and the reference image is derived and stored in the memory 239. As the alignment information (second alignment information) by sheet vertices, for example, an affine matrix performing affine transformation is used.

At S407, the inspection module 109 transforms the inspection image into the shape of a sheet based on the positions of the sheet vertices obtained at S406. Further, in a case where this transformation is performed, it may also be possible to include processing to convert the resolution of the captured image into a predetermined resolution. Normally, by the influence of the skew of a sheet and variations of the conveyance speed, the shape of the image corresponding to the sheet in the captured image is distorted. For example, in a case where the size of the inspection-target sheet for which inspection processing is performed is the LTR size (215.9 mm×279.4 mm), the resolution is 300 dpi in the main scanning direction, and 300 dpi in the sub scanning direction, the shape of the above-described sheet will be the shape shown below. That is, the shape of the above-described sheet is a rectangle whose length WR in the main scanning direction is 11 inch×300=3,300 pixel and whose length HR in the sub-scanning direction is 8.5 inch×300=2,550 pixel. The shape of the sheet can be represented by coordinates of four points, that is, (0, 0), (3,299, 0), (0, 2,549), and (3,299, 2,549). The inspection module 109 transforms the image data so that the positions of the four points of the sheet vertices obtained from the image and the positions of the four points of the shape of the sheet for which the inspection processing set in advance is performed match. As the image transformation method such as this, there exists an already-known method, such as affine transformation also called geometrical transform. By the processing at S403 and S404, it is possible to convert the scanned reference image into the inspection-target sheet size.

At S408, the inspection module 109 derives feature points that can be extracted from the inspection image. The feature point indicates a portion in the image suitable to perform alignment of the entire image in a case where the image is compared with the reference image in inspection processing, to be described later. As the feature point suitable for alignment of the entire image, there is a point whose corner feature amount within the image is large. The corner feature is a feature in which two conspicuous edges whose directions are different exist in the vicinity of a certain limited area. The corner feature amount is an amount representing the strength of the edge feature. Further, it is desirable for the feature points for performing alignment of the entire image to be distributed at positions distant to a certain extent from one another because the amount of misalignment becomes large at a position distant from the feature point in a case where the feature points are subject to a certain area in the image. Consequently, the inspection module 109 extracts feature points existing at positions distributed in the entire image from among points whose corner feature amount described previously is large as the feature points for the use of the derivation of alignment information by feature points. The extraction of feature points will be described later by using the drawing.

At S409, the inspection module 109 determines whether the number of feature points derived at S408 is less than a predetermined number (certain number), for example, such as four. The predetermined number (certain number) is a number sufficient for alignment of the image. In a case where the number of feature points is less than the predetermined number, the inspection module 109 determines that an image whose number of feature points that can be extracted is small is inspected and an operation before inspection in a case where the number of feature points that can be extracted is small is selected. In a case where the inspection module 109 determines that the number of feature points is not less than the predetermined number (NO at S409), the processing is moved to S410. In a case where the inspection module 109 determines that the number of feature points is less than the predetermined number (YES at S409), the processing is moved to S412. In the present embodiment, thought the determination is performed by using the number of feature points that can be extracted from the inspection image, it may also be possible to derive the number of feature points that can be extracted from the reference image at S408 and use the number of feature points extracted from the reference image for determination at S409.

At S410, the inspection module 109 derives alignment information (first alignment information) by feature points for performing alignment of the inspection image and the reference image and stores the alignment information in the memory 239. That is, the inspection module 109 derives alignment information (first alignment information) by feature points by using the feature points of the inspection image, which are extracted from the inspection image at S408, and the feature points of the reference image, which are extracted at S403 and correspond to the feature points of the inspection image, and stores the alignment information in the memory 239. As the alignment information (first alignment information) by feature points, for example, an affine matrix performing affine transformation is used.

At S411, the inspection module 109 stores the derived alignment information in the memory 239 as previous alignment information. That is, the inspection module 109 stores the alignment information (second alignment information) by sheet vertices, which is derived at S406, in the memory 239 as previous alignment information by sheet vertices. The inspection module 109 stores the alignment information (first alignment information) by feature points, which is derived at S410, in the memory 239 as previous alignment information by feature points (inspected sheet feature point information). Due to this, the memory 239 stores the alignment information by sheet vertices, which is derived at S406, the alignment information by feature points, which is derived at S410, the previous alignment information (inspected sheet feature point information), and the previous alignment information by sheet vertices.

At S412, the inspection module 109 checks whether the memory 239 stores the previous alignment information (inspected sheet feature point information). In a case where check results that the memory 239 stores the inspected sheet feature point information are obtained (YES at S412), the processing is moved to S414 for performing estimation of alignment information by using the inspected sheet feature point information. In a case where check results that the memory 239 does not store the inspected sheet feature point information are obtained (NO at S412), the processing is moved to S413 for using the alignment information by only the positions of four points of sheet vertices.

At S413, the inspection module 109 stores the alignment information (second alignment information) by sheet vertices in the memory 239, which is derived at S406 and stored in the memory 239, as alignment information to be used.

At S414, the inspection module 109 performs estimation of alternative alignment information by using the previous alignment information by sheet vertices and the previous alignment information by feature points, both stored in the memory 239, and the alignment information by sheet vertices derived at S406. That is, the inspection module 109 estimates alternative alignment information from the alignment information by feature points, which was used in the past alignment, and the alignment information by sheet vertices, which was derived in the past alignment and derived in the current alignment. Details of the estimation of alternative alignment information will be described later by using the drawing.

At S415, the inspection module 109 stores the alternative alignment information estimated at S414 in the memory 239 as the alignment information to be used. The alternative alignment information is estimated from the previous alignment information by feature points, and therefore, it can be said that the alternative alignment information is information corresponding to the alignment information by feature points.

At S416, the inspection module 109 receives a print job for inspection from the client PC 103, detects the conveyance of a sheet, scans the sheet with the image capturing unit 240, and stores the scanned image in the memory 239 of the inspection module 109. Then, the inspection module 109 inspects the image obtained by scanning the inspection job and the reference image registered at S401 by using the alignment information to be used, which is stored at one of S410, S413, and S415.

At S417, the inspection module 109 determines whether the inspection processing of all the pages is completed. In a case where determination results that the inspection processing of all the pages is not completed are obtained (NO at S417), the processing is returned to S404. In a case where determination results that the inspection processing of all the pages is completed are obtained (YES at S417), the flow shown in FIGS. 4A and 4B is terminated.

### <Detailed Setting of Inspection Method>

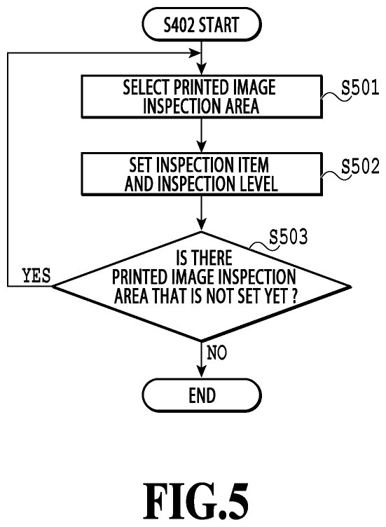

Next, details of the processing to set detailed information, such as the inspection level, the inspection type, and the inspection area in a case where a print-processed sheet is inspected, are explained by using the drawing. FIG. 5 is a flowchart showing a detailed flow of the processing to set the inspection method (S402). By performing the processing of the flowchart, the inspection module 109 sets various inspection parameters, such as the inspection area and the inspection level, of a printed image for inspecting the inspection image. Further, an example of the UI relating to the inspection setting is explained by using the drawing. FIG. 6 is a diagram showing a UI screen example relating to the inspection setting.

At S501, the inspection module 109 sets the inspection area of the printed image for inspecting the inspection image by receiving a user operation on the UI screen. A UI screen 600 has a text and image selection tool 602, buttons 603 for rotating a display, a button 611 for performing setting of an emphasis area, a button 612 for performing setting of a default area, a button 613 for performing setting of a brief area, and a button 614 for performing setting of a non-inspection-target area. The UI screen 600 has a page preview display area 620 of a printed image, a display area 640 of the setting of printed image inspection, an OK button 651, and a Cancel button 652.

In the page preview display area 620 of a printed image, a printed image 630 including an emphasis area 631, a default area 632, a brief area 633, and a non-inspection-target area 634 is displayed. It is assumed that the printed image 630 is the reference image registered at S401 and taken to be a reference of inspection. It is assumed that the emphasis area 631 is set to the area on the upper side of the printed image 630 and including a rectangle in which a black star mark and a black triangle are arranged. It is assumed that the default area 632 is set to the area on the lower side of the emphasis area 631 and on the bottom-right side of the printed image 630. It is assumed that the brief area 633 is set to the area on the lower side of the emphasis area 631 and at the center of the printed image 630. It is assumed that the non-inspection-target area 634 is set to the area on the lower side of the brief area 633 and on the bottom-left side of the printed image 630.

The display area 640 of the setting of the printed image inspection has a display area 641 of the setting of the emphasis area, a display area 642 of the setting of the default area, and a display area 643 of the setting of the brief area. The display area 641 of the setting of the emphasis area has an inspection level 6411 of a spot-shaped defect and an inspection level 6412 of a streak. Though an example is shown in which level 7 is set as the inspection level 6411 of a spot-shaped defect and the inspection level 6412 of a streak, respectively, the example is not limited to this. The display area 642 of the setting of the default area has an inspection level 6421 of a spot-shaped defect and an inspection level 6422 of a streak. Though an example is shown in which level 4 is set as the inspection level 6421 of a spot-shaped defect and the inspection level 6422 of a streak, respectively, the example is not limited to this. The display area 643 of the setting of the brief area has an inspection level 6431 of a spot-shaped defect and an inspection level 6432 of a streak. Though an example is shown in which level 2 is set as the inspection level 6431 of a spot-shaped defect and the inspection level 6432 of a streak, respectively, the example is not limited to this.

By the OK button 651 being pressed down by a user operation, the level in each area displayed in the setting of printed image inspection is set. By the Cancel button 652 being pressed down by a user operation, the level in each area displayed in the setting of printed image inspection is cancelled.

The procedure of a method of setting an inspection area of a printed image in the present embodiment is as follows.

In the present embodiment, four types of area setting are performed. Four types of area are an emphasis area, a default area, a brief area, and a non-inspection-target area. The emphasis area is an area, such as the face of a person, for which it is desired to perform defect inspection with particular emphasis compared to the other areas. The default area is an area for which it is desired to perform default inspection. The brief area is an area the inspection for which may be briefer than that for the default area. The non-inspection-target area is an area that is excluded from the inspection target.

A case is explained where the emphasis area is set. By a user operation, the “Setting of emphasis area” button 611 is pressed down. Next, by a user operation, a pointer (not shown schematically) is moved and a range is designated in the printed image 630 that is displayed in the page preview display area 620, for which it is desired to perform inspection with emphasis. By this designation, the inspection module 109 sets the corresponding designated range as the emphasis inspection area (in the following, also called “emphasis area”) 631.

A case is explained where the default area is set. By a user operation, the “Setting of default area” button 612 is pressed down. Next, by a user operation, a pointer is moved and a range is designated in the printed image 630 that is displayed in the page preview display area 620, for which it is desired to perform default inspection. By this designation, the inspection module 109 sets the corresponding designated range as the default inspection area (in the following, also called “default area”) 632.

A case is explained where the brief area is set. By a user operation, the “Setting of brief area” button 613 is pressed down. Next, by a user operation, a pointer is moved and a range is designated in the printed image 630 that is displayed in the page preview display area 620, for which it is desired to perform inspection briefly. By this designation, the inspection module 109 sets the corresponding designated range as the brief inspection area (in the following, also called “brief area”) 633.

A case is explained where the non-inspection-target area is set. By a user operation, the “Setting of non-inspection-target area” button 614 is pressed down. Next, by a user operation, a pointer is moved and by designating a range in the printed image 630 that is displayed in the page preview display area 620, which is desired to be excluded from the inspection target, the inspection module 109 sets the corresponding designated range as the non-inspection-target area 634.

At S502, the inspection module 109 sets the inspection item and the inspection level thereof with which a defect is detected in the printed image inspection on the UI screen 600.

The detection item of the printed image inspection is the item relating to the feature of a detect that is desired to be detected in a case where a printed material is inspected, for example, such as a circular defect (spot-shaped defect) and a linear defect (streak). The inspection level is a parameter that is set for each level at which what size is determined to be a defect for each feature of a detected defect. For example, there are seven levels from level 1 to level 7 and with level 1, it is possible to detect a defect that is thinner and smaller in size than in the case of level 7. Further, it is possible to set the level for each inspection item, such as that a spot-shaped defect is detected with level 7 and a streak is detected with level 4. The number of levels of parameters and levels are not limited to the above. The UI screen 600 indicates that level 7 is selected by a user for the inspection level setting of a defect (spot-shaped defect) and level 7 is selected by a user for the inspection level setting of a defect (streak). The top-left coordinates of the area designated in the page preview display area 620 are stored as start coordinates and the bottom-right coordinates thereof are stored as end coordinates.

At S503, whether there is an inspection area of the printed image, which is not set yet, is determined. In a case where determination results that there is an inspection area of the printed image, which is not set yet, are obtained (YES at S503), the processing is returned to S501 and the processing at S501 and the subsequent steps is performed for the inspection area of the printed image, which is not set yet. In a case where determination results that there is no inspection area of the printed image, which is not set yet, are obtained (NO at S503), the flow shown in FIG. 5 is terminated.

The above is the explanation of the processing relating to the detailed setting, such as the inspection level, the inspection type, and the inspection area, of the printed image inspection at S402.

### <Calculation Method of Feature Point Information>

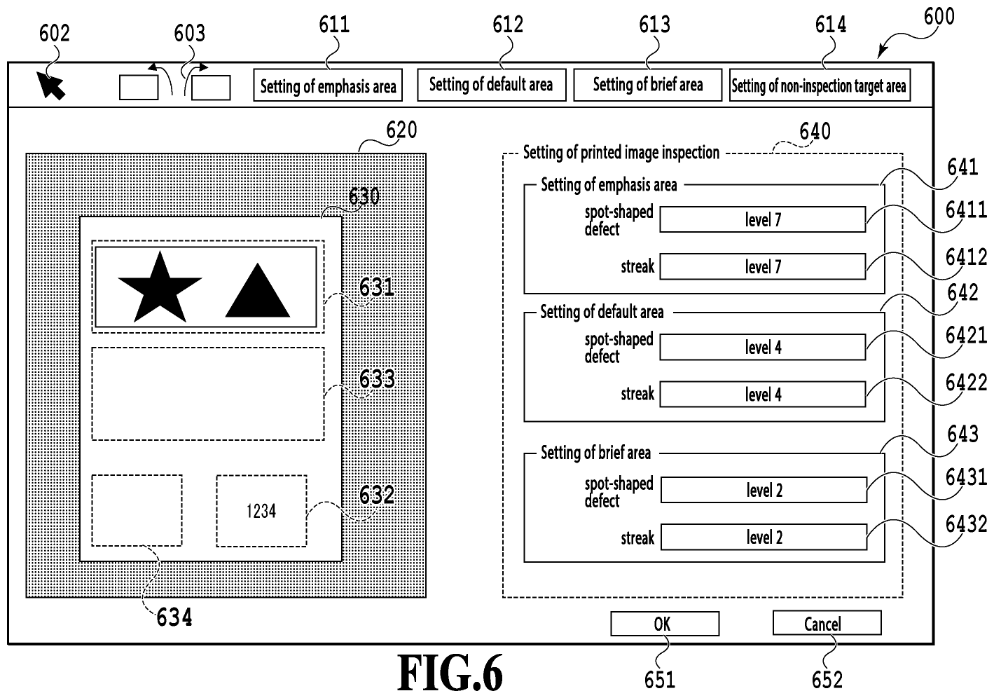

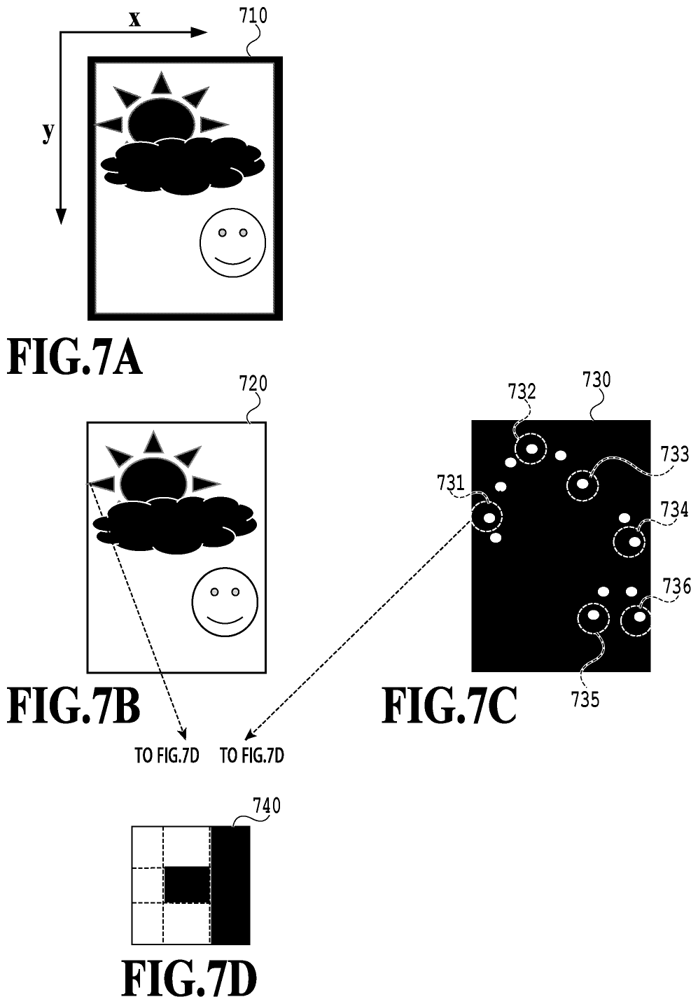

The calculation method of feature point information is explained by using the drawings. FIG. 7A to FIG. 7D are diagrams explaining the feature point extraction that is performed at S408. FIG. 7C shows the image after the Harris corner detection method is performed and FIG. 7D shows the image of the extracted feature points. FIG. 7A to FIG. 7D each show a case where the number of feature points that can be extracted is larger than or equal to a certain number and the positions of the extracted feature points are not subject to a certain area.

FIG. 7A shows an image (reference image) 710 obtained by the image capturing unit 240 performing image capturing. The reference image 710 includes four sheet vertices corresponding to the sheet. FIG. 7B shows an image 720 after image transformation using the sheet vertices is performed for the reference image 710. As explained at S408, as a feature point suitable for alignment of the entire image, there is a point whose edge within the image is large.

For the feature point detection, a variety of methods have been devised. As one of methods of calculating a feature point, there is a publicly known technique called the Harris corner detection method. In the Harris corner detection method, an edge image is calculated from a differential image in the main scanning direction and a differential image in the sub scanning direction. Details will be described later by using the drawing. This edge image is an image representing the edge amount of the weaker edge of the two edges configuring the feature point. The feature point is calculated based on whether even the relatively weaker edge has a strong edge amount though both two edges should be strong edges. FIG. 7C shows a state where the Harris corner detection method has been performed for the image 720 shown in FIG. 7B and the pixel having an edge whose value is larger than a predetermined value, for example, such as 100, is represented in white. There exists a plurality of points whose edge is comparatively large within the image and in the present embodiment, six points are extracted as feature points to be used for alignment, which are located at positions distributed in the entire image, from among points whose edge size is large. This time, it is desirable for the feature points to be arranged sparsely in the entire image, and therefore, six points that make the distribution closer to uniform distribution are selected. As the method of determining distribution, for example, there is a method that uses variance. In FIG. 7C, six extracted feature points 731, 732, 733, 734, 735, and 736 are shown as positions enclosed by white circular broken lines.

FIG. 7D shows an image 740 corresponding to the position of the feature point 731, which is one of the plurality of the extracted feature points in FIG. 7 and which includes 3 pixels square. In a flow of inspection processing, to be described later, for the read image (inspection image) of the print-processed sheet, which is the inspection target, the portion that matches the image as shown in FIG. 7D is searched for in the vicinity of the coordinates corresponding to the feature point. Due to this, it is possible to obtain coordinates of the feature point of the read image (inspection image) that is the inspection target.

### <Harris Corner Detection Method>

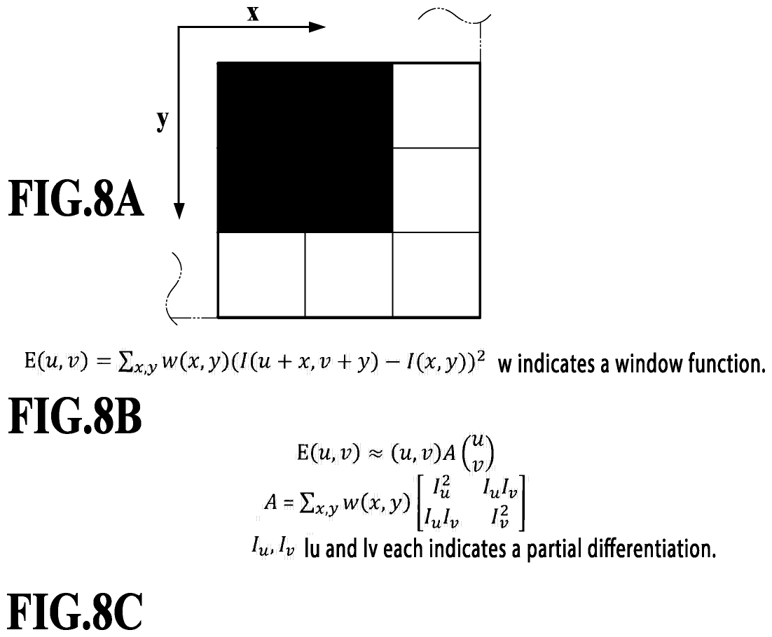

Details of the Harris corner detection method are explained by using the drawings. FIG. 8A to FIG. 8C are diagrams explaining the Harris corner detection method and FIG. 8A shows an image example to which the Harris corner detection method is applied, FIG. 8B shows a definition formula of E (u, v) that is used in the Harris corner detection method, and FIG. 8C shows an approximate formula.

In the Harris corner detection method, as shown in FIG. 8A, a point at which an edge appears strongly both in the x-direction and in the y-direction is defined as a feature point. At this time, in the Harris corner detection method, the weighted sum of squares of differences is defined by a formula shown in FIG. 8B by using a correlation of an image I itself and an image obtained by shifting the image I by (u, v). It is possible to approximate this formula to a formula as shown in FIG. 8C. At the feature point, the value of E (u, v) varies largely with respect to the change in (u, v). Because of this, in a case where eigenvalues λ₁ and λ₂ in a matrix A are sufficiently large as the strength of the edge, it can be said that the point indicates a feature point.

<Image with Small Number of Feature Points>

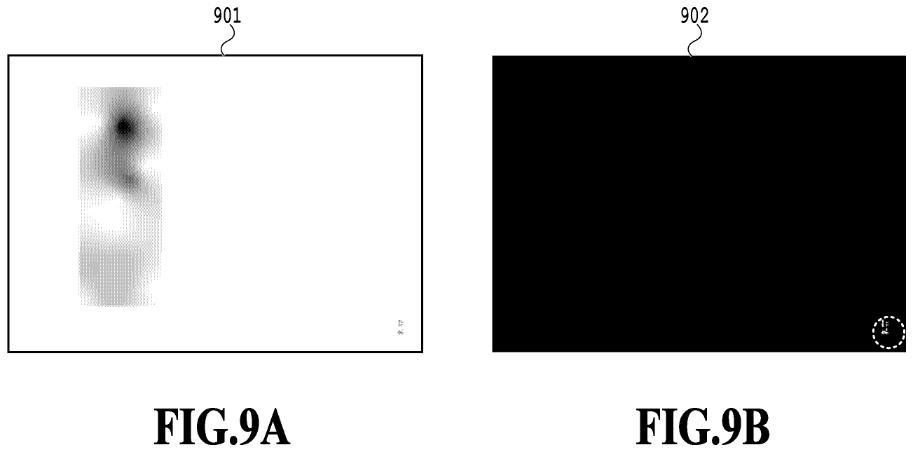

An image example in a case where the number of feature points is small and the positions of feature points are subject to a certain portion is explained by using the drawings. FIG. 9A and FIG. 9B each show an image example in a case where the number of feature points is small and the positions of feature points are subject to a certain portion. FIG. 9A shows an image (reference image) 901 obtained by the image capturing unit 240 performing image capturing.

An image with a small number of feature points occurs, for example, in a case where a reference image is registered by using a sheet in the state of a blank sheet on which no image is printed, or a sheet on which only patterns having only points whose corner feature amount is small are printed. There is a possibility that it is not possible to extract the number of feature points sufficient for image alignment from a read image obtained by reading the sheet such as this.

FIG. 9B shows an image example in which feature points are extracted at S408 from the reference image 901 shown in FIG. 9A. More specifically, FIG. 9B shows the state where the Harris corner detection method has been performed for the reference image 901 and the pixel having an edge whose value is larger than a predetermined value, for example, such as 100, is represented in white. An image 902 shown in FIG. 9B is in the state where points whose feature amount is large are subject to the area in the corner of the sheet, which is indicated by a broken-line circle in FIG. 9B. In a case where the CPU 238 extracts one of points whose feature amount is large such as this at S408 as a feature point, the other points whose feature amount is large are located at positions in very close proximity to the extracted feature point, and therefore, they are not extracted as feature points. In this case, even though feature points are extracted from the reference image, it may become difficult to perform alignment of the inspection image, which is the processing-target read image, for the reference image based on the feature points. Consequently, estimation of alignment information is performed.

### <Estimation of Alignment Information Using Inspected Sheet Feature Point Information>

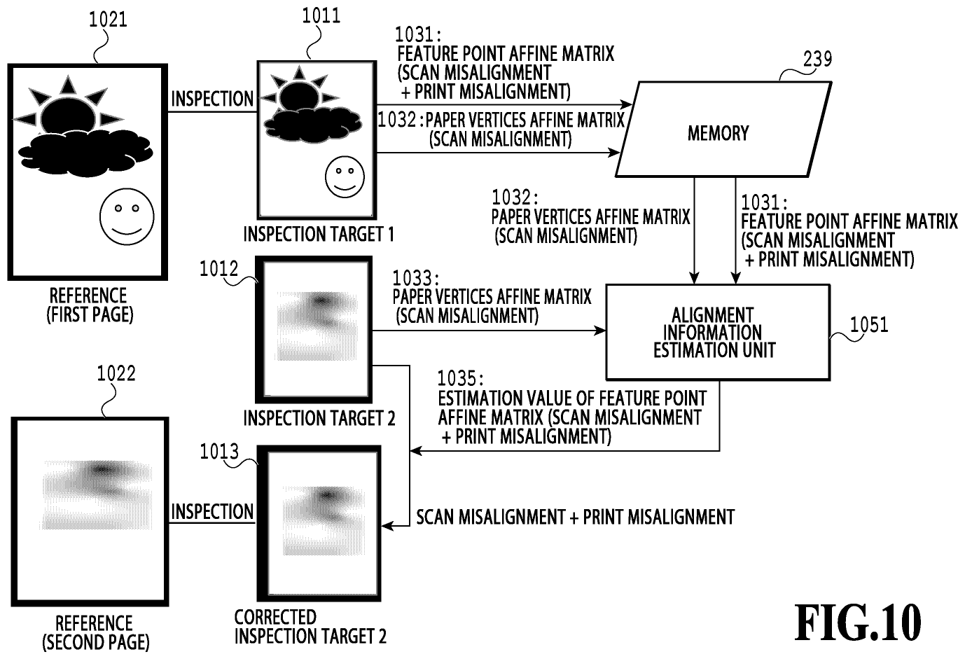

Details of a method of estimating alignment information are explained by using the drawing. FIG. 10 is a diagram for explaining the method of estimating alignment information. It is assumed that a reference of the first page includes an image having a plurality of points whose corner feature amount is large and it is possible to extract the number of feature points sufficient to perform alignment by feature points from the reference of the first page. It is assumed that a reference of the second page includes only patterns having only points whose corner feature amount is small and it is not possible to extract the number of feature points sufficient to perform alignment by feature points from the reference of the second page. An alignment information estimation unit 1051 shown in FIG. 10 is implemented by, for example, the CPU 238 of the inspection module 109 reading various programs stored in the memory 239 or the HDD 255 and controlling each unit. Further, it may also be possible to implement part of the configuration or the entire configuration shown in FIG. 10 by dedicated hardware, for example, such as an ASIC and an FPGA.

First, the inspection module 109 scans the print-processed sheet of the first page, which is the inspection target. Then, the inspection module 109 extracts feature points from a scanned image (inspection target 1) 1011 of the print-processed sheet of the first page and a reference image (reference (first page)) 1021 taken to be a reference of the inspection of the scanned image 1101, respectively. Then, by using the feature points of the reference image 1021 and the feature points of the scanned image 1011, a feature point affine matrix 1031 is derived, which is first alignment information for performing alignment of the reference image 1021 and the scanned image 1011. That is, as the first alignment information, the feature point affine matrix 1031 is derived, which is information for performing affine transformation of the coordinates of the feature points of one of the inspection image and the reference image into coordinates of the feature points of the other image. Further, the inspection module 109 detects the sheet vertices (paper vertices) from the scanned image 1011 and the reference image 1021, respectively. Then, by using the paper vertices of the reference image 1021 and the paper vertices of the scanned image 1011, a paper vertex affine matrix 1032 is derived, which is the second alignment information for performing alignment of the reference image 1021 and the scanned image 1011. That is, as the second alignment information, the paper vertex affine matrix 1032 is derived, which is information for performing affine transformation of the coordinates of the sheet four corners of one of the inspection image and the reference image into the coordinates of the sheet four corners of the other image. The inspection module 109 stores the feature point affine matrix 1031 and the paper vertex affine matrix 1032, both derived, in the memory 239. The paper vertex affine matrix 1032 stored in the memory 239 is information on the transformation for the information on the misalignment (scan misalignment) of the paper having occurred during a scan. The feature point affine matrix 1031 stored in the memory 239 includes the information on the misalignment (scan misalignment) of the paper having occurred during a scan and the information on the print misalignment having occurred during printing.

Following the above, the inspection module 109 scans the print-processed sheet of the second page, which is the inspection target. The inspection module 109 detects sheet vertices (paper vertices) from a scanned image (inspection target 2) 1012 of the print-processed sheet of the second page and a reference image (reference (second page)) 1022 taken to be a reference of the inspection of the scanned image 1022, respectively. By using the paper vertices of the scanned image 1012 and the paper vertices of the reference image 1022, a paper vertex affine matrix 1033 is derived, which is the second alignment information for performing alignment of the reference image 1022 and the scanned image 1012. The inspection module 109 stores the derived paper vertex affine matrix 1033 in the memory 239.

Here, CornerAffine [n−1] that is the paper vertex affine matrix 1032 of the first page stored in the memory 239 is taken to be C and FeatureAffine [n−1] that is the feature point affine matrix 1031 is taken to be F. CornerAffine [n] that is the paper vertex affine matrix 1033 of the second page obtained by the inspection module 109 is taken to be D. FeatureAffine [n] that is a feature point matrix 1035 to be estimated is taken to be G. It is assumed that the above-described G and the above-described F, C, and D have a relationship of G=F·C⁻¹·D. Consequently, the alignment information estimation unit (feature point affine estimation unit) 1051 of the inspection module 109 estimates G of the feature point affine matrix 1035, which is alternative alignment information, by calculating F·C⁻¹·D. That is, as the alternative alignment information, the feature point affine matrix 1035 is derived, which is information for performing affine transformation of the coordinates of the feature points of one of the inspection image and the reference image into the coordinates of the feature points of the other image.

### <Details of Inspection Processing (S416)>

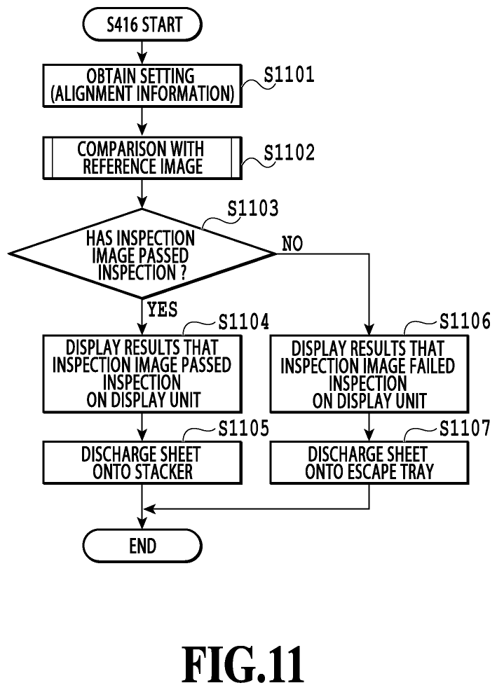

Details of the inspection processing (S416) that is performed by the inspection module 109 are explained by using the drawing. FIG. 11 is a flowchart showing a flow of the processing that is performed by the inspection module 109 at the time of performing inspection processing. The processing in FIG. 11 is performed by the CPU 238 of the inspection module 109.

At S1101, the inspection module 109 obtains the printing setting and alignment information. That is, the inspection module 109 obtains the setting information set at S402 and the alignment information to be used stored at S410, S413, or S415.

At S1102, the inspection module 109 compares the image (inspection image) read at S405 and the reference image taken to be a reference of the inspection of the read image (inspection image). The reference image that is used here is the image registered at S401 in FIG. 4A. Details of the processing of comparison with the reference image will be described later by using the drawing.

At S1103, the inspection module 109 determines whether the inspection image is a normal image or a defective image based on the results of the comparison with the reference image at S1102. That is, the inspection module 109 determines whether the inspection mage has passed the inspection. In a case where determination results that the inspection image is a normal image and has passed the inspection are obtained (YES at S1103), the processing is moved to S1104. In a case where determination results that the inspection image is a defective image and has failed the inspection are obtained (NO at S1103), the processing is moved to S1106.

At S1104, the inspection module 109 displays that the inspection results indicate that the inspection image has passed the inspection on the display unit 241 of the inspection module 109.

At S1105, the inspection module 109 instructs the printing module 107 to discharge the inspection-target print-processed sheet onto the stack tray 341 of the stacker 110. Then, based on the instructions of the inspection module 109, the printing module 107 instructs the stacker 110 to discharge the inspection-target print-processed sheet onto the stack tray 341.

At S1106, the inspection module 109 displays that the inspection results indicate that the inspection image has failed the inspection on the display unit 241 of the inspection module 109.

At S1107, the inspection module 109 instructs the printing module 107 to discharge the inspection-target print-processed sheet onto the escape tray 346 of the stacker 110. Then, based on the instructions of the inspection module 109, the printing module 107 instructs the stacker 110 to discharge the inspection-target print-processed sheet onto the escape tray 346. In a case where the processing at S1105 or S1107 is completed, the inspection processing shown in FIG. 11 is terminated.

<Details of Comparison Processing with Reference Image>

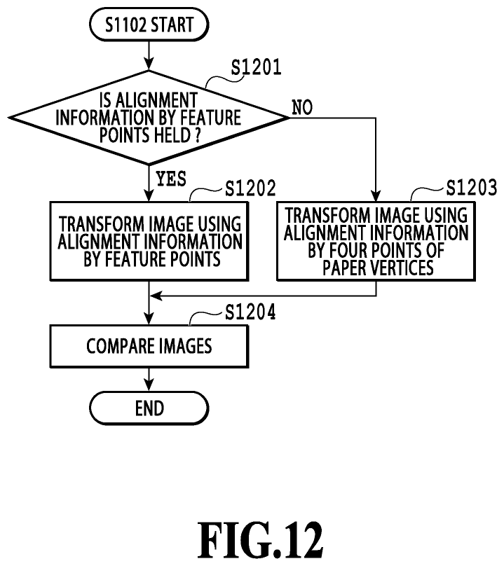

Details of the comparison processing with the reference image are explained by using the drawing. FIG. 12 is a flowchart showing a detailed flow of the comparison processing (S1102) with the reference image. The comparison processing with the reference image is performed by the inspection module 109 in the above-described inspection processing.

At S1201, the inspection module 109 determines whether the memory 239 stores the alignment information by feature points. In a case where determination results that the memory 239 stores the alignment information by feature points are obtained (YES at S1201), the processing is moved to S1202. In a case where determination results that the memory 239 does not store the alignment information by feature points are obtained (NO at S1201), the processing is moved to S1203.

At S1202, the inspection module 109 transforms the inspection image obtained at S405 based on the alignment information (alignment information by feature points) to be used, which is stored in the memory at S410 or S415. Due to this, the transformed inspection image becomes equivalent to an image for which alignment has been performed for the reference image.

At S1203, the inspection module 109 transforms the inspection image obtained at S405 based on the alignment information (alignment information by four points of paper vertices) to be used, which is stored at S413. Due to this, the inspection image is transformed so that the positions of the sheet vertices of the inspection image match the positions of the sheet vertices of the reference image and the transformed inspection image becomes equivalent to an image for which alignment has been performed for the reference image.

The image transformation by the processing at S1202 or S1203 described above may include processing to convert the resolution of the captured image (inspection image) into a predetermined resolution. The image transformation such as this is also called geometrical transform and there exists an already-known method, such as affine transformation. In the affine transformation, it is possible to find coefficients necessary for affine transformation processing from the coordinates of the portions desired to be matched between the image taken to be a reference (here, reference image) and the transformation-target inspection image.

At S1204, the inspection module 109 performs processing to compare the inspection image transformed by the processing at S1202 or S1203 and the reference image. By this comparison processing, the comparison results indicating that the inspection image is a normal image or the comparison results indicating that the inspection image is a defective image are obtained. After the comparison processing is completed, the flow shown in FIG. 12 is terminated.

For example, in a case where the difference between the pixel value (luminance value) of the inspection-target pixel in the inspection image transformed at S1202 or S1203 and the pixel value (luminance value) of the comparison-target pixel in the reference image is less than or equal to a threshold value, the inspection module 109 determines that the inspection-target pixel has passed (OK). It is assumed that the threshold value is different for each level. For example, it is assumed that at level 1 of the inspection level, the threshold value is 200, at level 2 of the inspection level, the threshold value is 180, at level 3 of the inspection level, the threshold value is 150, and at level 4 of the inspection level, the threshold value is 130. Further, it is assumed that at level 5 of the inspection level, the threshold value is 120, at level 6 of the inspection level, the threshold value is 100, and at level 7 of the inspection level, the threshold value is 50.

Further, in a case where the inspection of all the pixels configuring the inspection image transformed at S1202 or S1203 is completed, the inspection module 109 determines whether the sum total of pixels determined to have failed is less than or equal to a threshold value for pass. In a case where the sum total of pixels determined to have failed is less than or equal to the threshold value for pass, the inspection module 109 determines that the inspection image transformed at S1202 or S1203 to have passed (normal image). In a case where the sum total of pixels determined to have failed exceeds the threshold value for pass, the inspection module 109 determines the inspection image transformed at S1202 or S1203 to have failed (defective image).

As explained above, according to the present embodiment, the following effects can be obtained. That is, from the alignment information by feature points derived on the page before the inspection-target page, the alignment information by feature points in a case where it is not possible to extract the number of feature points larger than or equal to a certain number and to perform alignment by the alignment information by feature points is estimated (predicted). In other words, in a case where the number of feature points larger than or equal to a certain number are not extracted from the inspection-target inspection image and the reference image, from the alignment information by feature points that was used actually in the past alignment, alternative alignment information is estimated. Then, by transforming the inspection image by using the alternative alignment information, it is possible to perform alignment of the transformed inspection image for the reference image with a high accuracy. That is, even in a case where it is difficult to extract feature points from a printed material, it is possible to perform alignment of the reference image and the inspection image with a high accuracy, and therefore, it is possible to suppress a reduction in inspection accuracy, which results from misalignment.

In the present embodiment, though the case is described where the number of feature points is less than a predetermined number, it may also be possible to determine that it is not possible to extract feature points sufficient for image alignment also in a case here feature points are arranged along a straight line or in a case where feature points gather in one portion even though the number of feature points is larger than or equal to a predetermined number.

### Second Embodiment

In the present embodiment, an aspect is explained by using the drawing, in which alignment information by feature points is registered in advance before performing print processing and inspection processing. In the following, differences from the first embodiment are explained mainly. In the registration of the initial setting, parameters of the printing module 107 and the inspection module 109 are adjusted by using a chart. At this time, by registering alignment information (parameters) by feature points in advance, it is made possible to perform inspection using the registered alignment information by feature points from the first page of the inspection target.

### <Flow of Entire Inspection Processing>

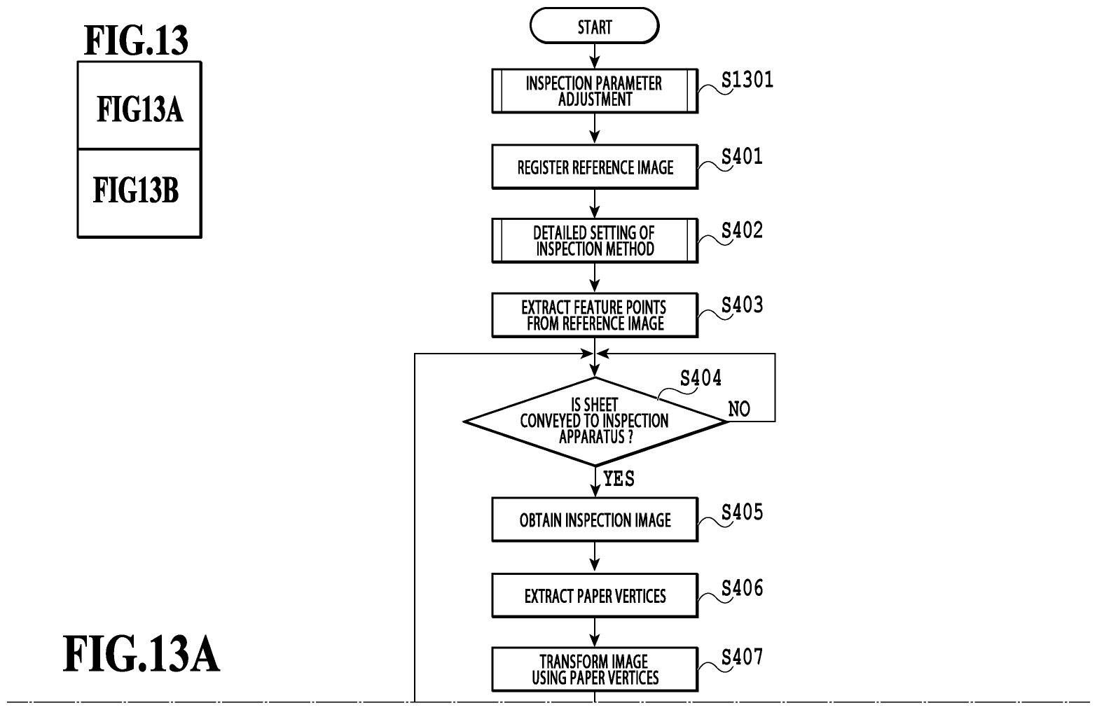

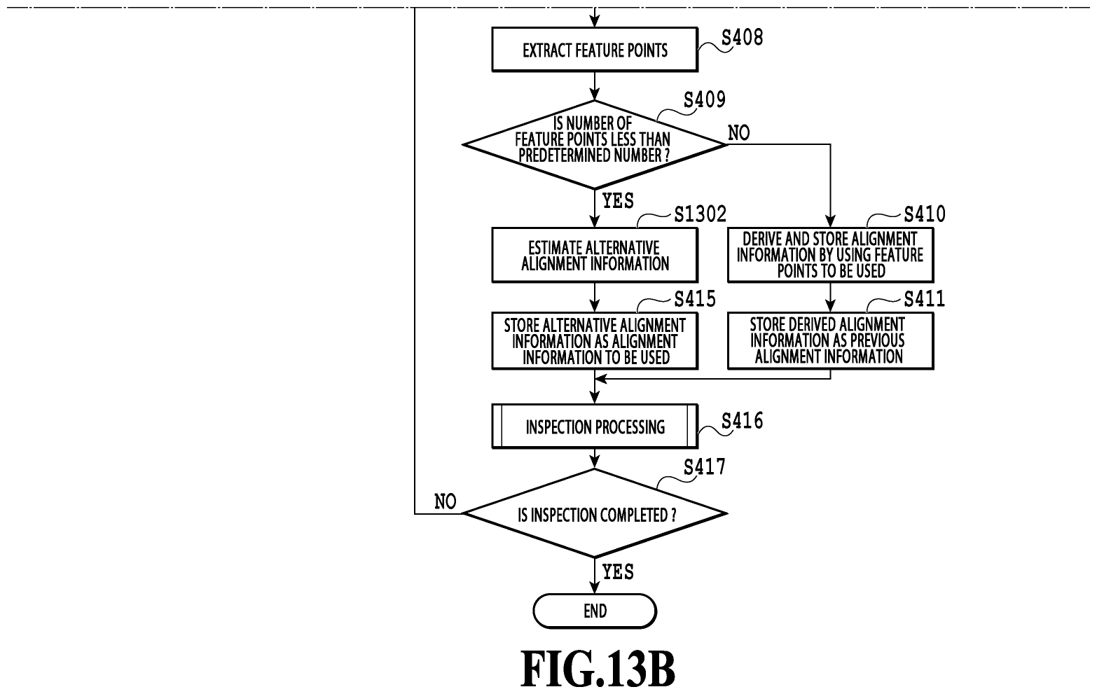

The flow of the entire inspection processing by the inspection module 109 of the printing system according to the present embodiment is explained by using the drawing. FIGS. 13A and 13B are flowcharts showing the flow of the entire inspection processing by the printing system according to the present embodiment. In the following, differences from the first embodiment are explained mainly.

At S1301, the printing module 107 receives printing for adjusting parameters of the inspection module 109. Upon receipt of printing, a chart determined in advance is printed, in which a feature point image having feature points more than or equal to a certain number is formed. Then, this chart is read and alignment information by feature points, which is adjusted inspection parameters, is derived and registered by using feature points extracted from the reference image of the feature point image and reading results, respectively. Further, from the reading results, sheet four corners are detected. By using the detected results and the sheet four corners of the reference image of the feature point image, alignment information by sheet four corners, which is adjusted inspection parameters, is derived and registered. That is, it can be said that the alignment information by feature points and the alignment information by sheet four corners are derived and registered before inspection processing is performed and they are derived by the parameter adjustment for alignment.

At S1302, the inspection module 109 estimates alternative alignment information in a case where it is not possible to extract feature points more than or equal to a certain number as shown in the following. That is, the inspection module 109 estimates alternative alignment information from the previous alignment information by feature points and sheet four corners stored in the memory and the alignment information by sheet four corners derived at S406. Further, the inspection module 109 estimates alternative alignment information from the alignment information by feature points and the alignment information by sheet four corners, both registered at S1301, and the alignment information by sheet four corners derived at S406.

### <Inspection Parameter Adjustment Processing>

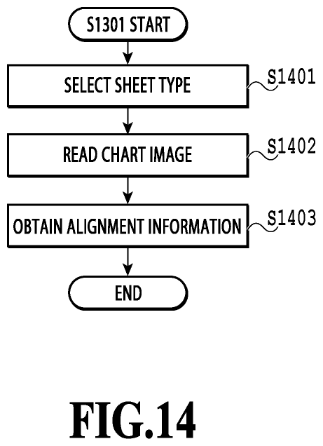

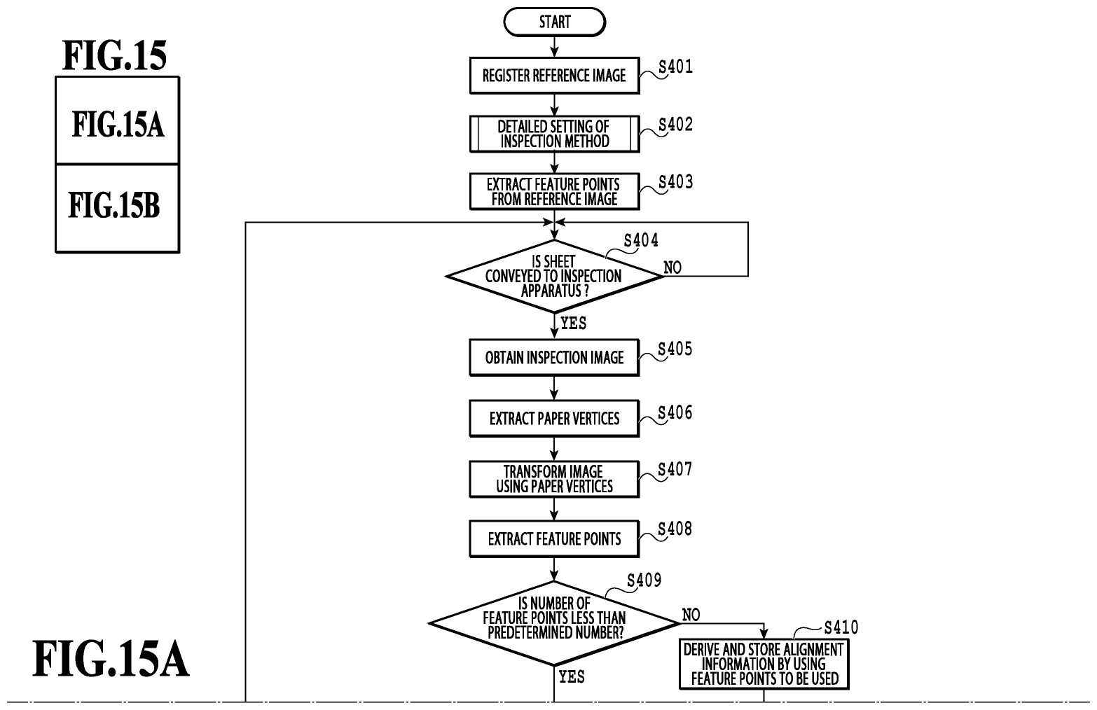

Details of inspection parameter adjustment processing are explained by using the drawing. FIG. 14 is a flowchart showing a detailed flow of the inspection parameter adjustment processing (S1301).

At S1401, first, the inspection module 109 selects a sheet type to be used in printing, which is desired to be inspected. The reason is that in a case where alignment parameters are estimated as initial parameters, the amount of misalignment changes for each sheet type and parameters are different for each sheet type.

At S1402, the inspection module 109 scans a parameter adjustment chart printed by the printing module 107. The parameter adjustment chart is determined in advance and for example, the parameter adjustment chart is required only to be a chart on which a feature point image having feature points more than or equal to a certain number is formed as shown in FIG. 7A. Further, it is assumed that the sheet type in a case where the parameter adjustment chart is printed is the same as that to be inspected.

At S1403, the inspection module 109 extracts feature points. The feature point extraction algorithm is the same as that described previously. By using the feature points thus extracted and the feature points of the reference image of the parameter adjustment chart, alignment information by feature points is derived. It is possible to use the alignment information by feature points as values in a case where estimation of alignment information at S1302 is performed during subject printing.

As explained above, according to the present embodiment, by obtaining feature points by using the chart and registering alignment information by feature points derived from the obtained feature points in advance as the initial setting, the following effect can be obtained. That is, it is possible to estimate alternative alignment information from the alignment information by feature points registered in advance before inspection even in a case where it is not possible to extract feature points more than or equal to a certain number. Because of this, it is made possible to perform alignment of the inspection image for the reference image with a high accuracy from the first page by using the alternative alignment information.

Further, it may also be possible to obtain feature points by reading the chart at the time of shipping, not only immediately before inspection. That is, it may also be possible to register the feature points obtained by reading the chart as the initial setting in advance. It may also be possible to use the feature points obtained by reading the chart as the past alignment information.

Further, it may also be possible to estimate alignment information (parameters) by feature points by using a correlation between the weight and size of the sheet and the amount of misalignment in a case where the amount of misalignment changes for each sheet type and register the estimated alignment information (parameters) by feature points as the initial values.

### Third Embodiment

In the present embodiment, an aspect is explained by using the drawing, in which whether to store as alignment information is determined in accordance with calculation results of reliability. In the following, differences from the first embodiment are explained mainly.

### <Flow of Entire Inspection Processing>

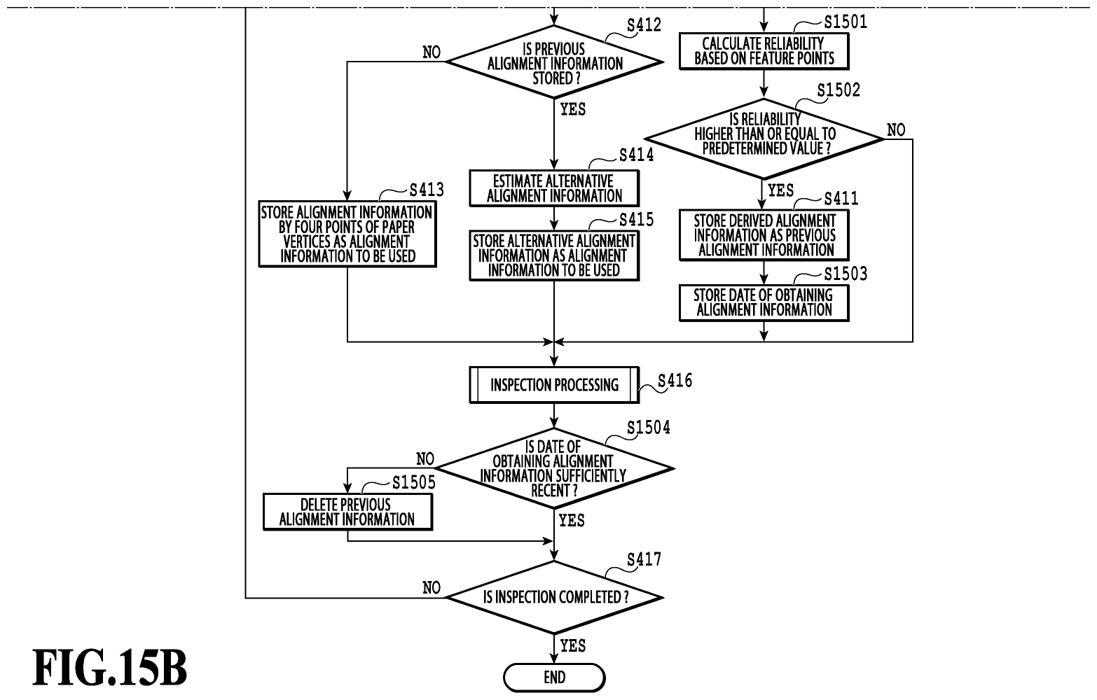

A flow of entire inspection processing by the inspection module 109 of the printing system according to the present embodiment is explained by using the drawing. FIGS. 15A and 15B is a flowchart showing a flow of the entire inspection processing by the printing system according to the present embodiment. FIGS. 15A and 15B show the entire flow from the work before inspection by the inspection module 109 starts to the execution of inspection.

First, at S1501, the inspection module 109 investigates the distribution of feature points and calculates reliability based on the distribution of feature points. In a case where the distribution of feature points is subject to a certain area, reliability less than a predetermined threshold value is calculated. On the other hand, in a case where the distribution of feature points is not subject to a certain area, reliability higher than or equal to the predetermined threshold value is calculated.

At S1502, the inspection module 109 determines whether the reliability calculated at S1501 is higher than or equal to the predetermined threshold value. That is, the inspection module 109 determines whether the distribution of feature points is spread across the entire area and not subject to a certain area. In a case where the coordinates of each feature point in the main scanning direction and in the sub scanning direction are found and for example, determination results that the covariance of the coordinates is less than a predetermined threshold value are obtained (NO at S1502), the distribution of feature points is determined to be subject to a certain area and determined to be one that cannot be used for general purposes. Then, the features points are determined to be those which cannot be trusted sufficiently to use for the subsequent alignment parameter estimation, and therefore, the previous alignment information is not updated. Though the example is shown here in which determination is performed based on the distribution of feature points, the example is not limited to this. For example, it may also be possible to perform determination in association with the number of feature points, such as in a case where the number of feature points is smaller than or equal to a predetermined number and the distribution of feature points is subject to a certain area. That is, the processing is moved to S416. On the other hand, in a case where determination results that the covariance of the coordinates of each feature point, which are found in the main scanning direction and in the sub scanning direction, is higher than or equal to a predetermined value are obtained (YES at S1502), the distribution of feature points is determined not to be subject to a certain area and determined to be those which can be used for general purposes. Then, the feature points are determined to be those which can be trusted sufficiently to use for the subsequent alignment parameter estimation, and therefore, the previous alignment information is updated. That is, the processing is moved to S411.

At S1503, the inspection module 109 stores the date of obtaining the alignment information that is used for estimation in the memory 239. Due to this, it is made possible to delete the alignment information in accordance with the date of updating alignment information, whose details will be described later.

At S1504, the inspection module 109 checks whether the previous alignment information stored in the memory is sufficiently recent information. That is, the inspection module 109 checks whether the previous alignment information stored in the memory is information for which a predetermined period of time has elapsed from the obtaining date. As the predetermined period of time, it may also be possible to use the number of times of inspection processing performed per day and the number of days of operation from the obtaining date of the previous alignment information stored in the memory to the current date, for example, such as 500,000 sheets and 20 days of operation. That is, it may also be possible to check whether the image forming apparatus 101 has processed inspection images more than or equal to a predetermined number. Alternatively, it may also be possible to use the number of days of no operation from the obtaining date of the previous alignment information stored in the memory to the current date, for example, such as seven days of no operation, as the predetermined period of time. That is, it may also be possible to check whether the image forming apparatus 101 is not in operation for a predetermined time or more. In a case where check results that the previous alignment information stored in the memory is sufficiently recent information for which the predetermined period of time has not elapsed are obtained (YES at S1504), the processing is moved to S417. On the other hand, in a case where check results that the previous alignment information stored in the memory is old information for which the predetermined period of time has elapsed are obtained (NO at S1504), the processing is moved to S1505.

At S1505, the inspection module 109 deletes and discards the alignment information stored in the memory from the memory. After the alignment information stored in the memory is deleted, the processing is moved to S417.

As explained above, according to the present embodiment, it is possible to determine whether the alignment information stored in the memory can be used in accordance with reliability of the alignment information, which is calculated based on extracted feature points. Due to this, it is made possible to deal with an error that is caused by the change in environment and the change in the amount of misalignment due to wear, or estimation using a small number of feature points.

### OTHER EMBODIMENTS

In the above, the aspect is explained in which in a case where feature points more than or equal to a certain number are not extracted from the inspection image, alternative alignment information is estimated from the first alignment information used in the past alignment and the second alignment information derived in the past alignment and the current alignment. The aspect is not limited to this. For example, it may also be possible to estimate the alternative alignment information from the first alignment information used in past alignment in a case where feature points more than or equal to a certain number are not extracted from the inspection image.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the present embodiment, even in a case where it is difficult to extract feature points from the inspection image of a printed material and the reference image, it is possible to perform alignment of the reference image and the inspection image with a high accuracy.

This application claims the benefit of Japanese Patent Application No. 2022-119235, filed Jul. 27, 2022, which is hereby incorporated by reference wherein in its entirety.

What is claimed is:

1. An image processing apparatus that performs image processing for performing alignment of an inspection image obtained by reading a printed material and a reference image of the inspection image, the image processing apparatus comprising:
an extraction unit configured to extract feature points from the inspection image and the reference image, respectively;
a first derivation unit configured to derive first alignment information for performing alignment of the inspection image and the reference image by using feature points extracted from the inspection image and the reference image, respectively; and
an alignment unit configured to perform alignment of the inspection image and the reference image by using the first alignment information, wherein
the alignment unit performs, in a case where feature points more than or equal to a certain number are not extracted from the inspection image and the reference image, alignment by using alternative alignment information by estimating the alternative alignment information from the first alignment information used in past alignment or the first alignment information derived by parameter adjustment for the alignment.

2. The image processing apparatus according to claim 1, wherein
in a case where feature points more than or equal to a certain number are extracted from the inspection image and the reference image, the first alignment information derived by the first derivation unit is stored in a memory and
the alignment unit estimates the alternative alignment information from the first alignment information stored in the memory.

3. The image processing apparatus according to claim 1, wherein
the first alignment information derived by parameter adjustment for the alignment is derived and stored in a memory by using feature points obtained by reading a chart on which a feature point image having feature points more than or equal to a certain number is formed and extracting from a reference image of the feature point image and reading results, respectively and
the alignment unit estimates the alternative alignment information from the first alignment information stored in the memory.

4. The image processing apparatus according to claim 2, wherein
the first alignment information stored in the memory is updated to, in a case where feature points more than or equal to a certain number are extracted from the inspection image and the reference image by current alignment, the first alignment information derived by the current alignment.

5. The image processing apparatus according to claim 2, wherein
the first alignment information stored in the memory is deleted in a case where the image processing apparatus has processed a predetermined number of inspection images or more or the image processing apparatus is not activated for a predetermined time or longer.

6. The image processing apparatus according to claim 2, wherein
in a case where though feature points more than or equal to a certain number are extracted from the inspection image and the reference image, a distribution of the feature points extracted by the extraction unit is subject to a certain area, the first alignment information derived by the first derivation unit is not stored in the memory.

7. The image processing apparatus according to claim 2, having:
a second derivation unit configured to derive second alignment information for performing alignment of the inspection image and the reference image by detecting sheet four corners from the inspection image and the reference image, respectively and using detected sheet four corners, wherein
the alignment unit performs, in a case where feature points more than or equal to a certain number are not extracted from the inspection image and the reference image, alignment by using the alternative alignment information by estimating the alternative alignment information from the first alignment information used in the past alignment or the first alignment information derived by parameter adjustment for the alignment and the second alignment information derived by the past alignment and current alignment.

8. The image processing apparatus according to claim 7, wherein
in a case where feature points more than or equal to a certain number are extracted from the inspection image and the reference image, the second alignment information derived by the second derivation unit is stored in the memory and
the alignment unit performs alignment by using the second alignment information derived by the second derivation unit in a case where feature points more than or equal to a certain number are not extracted from the inspection image and the reference image and the first alignment information used in the past alignment and the first alignment information derived by parameter adjustment for the alignment are not stored in the memory.

9. The image processing apparatus according to claim 1, wherein
the first alignment information is information for performing affine transformation of coordinates of feature points of one of the inspection image and the reference image into coordinates of feature points of the other image.

10. The image processing apparatus according to claim 7, wherein
the second alignment information is information for performing affine transformation of coordinates of sheet four corners of one of the inspection image and the reference image into coordinates of sheet four corners of the other image.

11. The image processing apparatus according to claim 1, wherein
the alternative alignment information is information for performing affine transformation of coordinates of feature points of one of the inspection image and the reference image into coordinates of feature points of the other image.

12. The image processing apparatus according to claim 1, further having:
an inspection unit configured to inspect a blot on the inspection image by comparing the inspection image and the reference image after alignment by the alignment unit.

13. An image processing method that performs image processing for performing alignment of an inspection image obtained by reading a printed material and a reference image of the inspection image, the image processing method comprising the steps of:
extracting feature points from the inspection image and the reference image, respectively;
deriving first alignment information for performing alignment of the inspection image and the reference image by using feature points extracted from the inspection image and the reference image, respectively; and
performing alignment of the inspection image and the reference image by using the first alignment information, wherein
in the performing, in a case where feature points more than or equal to a certain number are not extracted from the inspection image and the reference image, alignment is performed by using alternative alignment information by estimating the alternative alignment information from the first alignment information used in past alignment or the first alignment information derived by parameter adjustment for the alignment.

14. A non-transitory computer readable storage medium storing a program for causing a computer to execute an image processing method that performs image processing for performing alignment of an inspection image obtained by reading a printed material and a reference image of the inspection image, the image processing method comprising the steps of:
extracting feature points from the inspection image and the reference image, respectively;
deriving first alignment information for performing alignment of the inspection image and the reference image by using feature points extracted from the inspection image and the reference image, respectively; and
performing alignment of the inspection image and the reference image by using the first alignment information, wherein
in the performing, in a case where feature points more than or equal to a certain number are not extracted from the inspection image and the reference image, alignment is performed by using alternative alignment information by estimating the alternative alignment information from the first alignment information used in past alignment or the first alignment information derived by parameter adjustment for the alignment.
